(19) United States
(12) Patent Application Publication
(10) Pub. No.: US 2003/0167203 A1
(43) Pub. Date: Sep. 4, 2003

(54) Retail purchase coupon processing apparatus and methods

(75) Inventors: Gale H. Thorne, Bountiful, UT (US); James V. Yardley, Centerville, UT (US); Kay L. Ruggles, Salt Lake City, UT (US); Bruce W. Thorne, Payson, UT (US)

Correspondence Address: Mr. Gale H. Thorne, 1056 Millcrest Circle, Bountiful, UT, 84010, US

(73) Assignee: Gale H. Thorne Trust, Bountiful, UT (US)

(21) Appl. No.: 10/078,697

(22) Filed: Feb. 19, 2002

(51) Int. Cl. G06F 17/60

(52) U.S. Cl. 705/14

(57) ABSTRACT

Novel methods and apparatus for processing product sales coupons in a self-service environment comprising a coupon processing station which reads indicia from printed coupons and which provides opportunity for selection of electronically stored coupons from memory. Further, the station has multiple booths which may be used separately and which may be used to display advertising when not processing coupons. The coupon processing station dispenses a coupon shopping list having a list of selected coupons and a single machine-readable indicia, such as a bar code, from which all coupons on the list are referenced at the time of purchase. A list insertion hub affixed to an establishment cash register/computer communication system in which the station and hub are used verifies purchases against coupon use rules and validates each coupon which has been redeemed properly. Files of validated coupons are sorted and sent to a central controller for efficacious billing. The central controller receives new and modified coupon data from coupon originators for transmission and subsequent use at the station and hub. The controller also sorts and bills each coupon originator for subsequent remuneration to the store or establishment. Also, coupon purchasing lists may be generated on a home computer via interaction with the controller over the Internet.

### FIELD OF INVENTION

This invention relates to apparatus and methods by which manufacturer, or retail purchase, coupons are processed in a self service environment. More particularly, this invention relates to processors for manufacturer or retail purchase coupons whereby clerical staffs and management of a retail store are substantially relieved of work and effort required to process such coupons.

### BACKGROUND OF THE INVENTION

It is widely known that coupons are used as incentives to enhance sales of a target product and have been so used for over half a century. Manufacturers often issue such coupons via printed media such as newspapers, magazines, mailings, Internet and the like. Commonly incentives involve a certain amount to be taken off a retail price. Such coupons are carried to a store and exchanged for a price reduction when the purchase is made.

While distribution of coupons represents a well tried, successful discipline for sales campaigns, there are many problems associated with both handling and processing coupons. As an example, customers are imposed upon to cut-out, collect and carry coupons to a store, to select items from what may be a raft of coupons collected prior to shopping and to deliver those coupons used in each related sale to a clerk at a check stand. Ofttimes, customers arrive at a store having inadvertently left coupons at home or in another purse or the like. Collected coupons may remain in a collection for a period unused and neglected with some becoming outdated. More often, coupons, when published and available may not match current customer needs. For manufacturers, coupons often provide the basis of a long planned and expensive sales campaign. In today's environment, sales campaigns must be planned sufficiently far ahead to allow publication, delivery to a prospective customer, extraction from the publication by the prospective customer and final delivery of each selected coupon by the customer to a store for redemption.

Generally, coupon sales incentives represent a significant portion of a sales price (e.g. $1.00 off on a normal retail package price of $2.50 or 10¢ off on a 49¢ item). In any event, it is common for a coupon to represent a significant price reduction to enhance buying motivation.

The need to protect against premature leaks of product information is not the only source of security required by the coupon originator. To be successful, the third party provider must be a single source provider for training courses distributed through its server. For this reason, coupons and associated data sent by a coupon originator for distribution by the controller must be also protected from pirating by unethical controller accessors.

For a manufacture, price reduction as a sales incentive is only a portion of the cost of each coupon. Other costs which are effectively subliminal to a customer are publication and distribution costs of the coupons, a handling fee generally paid to a retailer for handling the coupons, and costs related to processing returned coupons before paying the handling fee and refunding cost of coupon incentives to each retailer. In addition, while a coupon price reduction represents a significant portion of a retail sales price, that reduction is an even greater portion of a wholesale cost and value of the item for which the coupon is used.

Since coupons are widely distributed, there is a significant likelihood that not all coupons remitted to a manufacturer have been used in a product sales transaction. Some may have been submitted sans purchase. While such an unscrupulous act may happen seldomly, there is certainly no effective way of validating appropriate coupon use except, perhaps, by correlation of wholesale delivery of product to a store compared with coupons remitted during any particular period. Since it may be anticipated that not all product delivered to a retailer would be purchased using a coupon during even effective sales campaigns, such correlations would be flawed at best.

However, the greatest bane of coupons may be borne by a participating retailer. Currently, most coupons are processed at time of purchase, i.e. at a check-out stand, usually at the completion of check-out during a transaction. Such processing is time consuming, ofttimes involving a customer's sorting through a number of coupons to separate those used in the purchase at hand. It is common practice, then, for each coupon to be scanned and read by a bar code reader and a determination made as to whether or not the coupon is out-of-date. If the coupon is out-of-date another time consuming discussion can result, a discussion which is frustrating for the cashier, the customer, other customers in-line to be checked out and the manager who sees valuable cash register time being wasted. Certainly, processing rate of customers through a check-stand is critical for retailers. Loss of efficiency in checking out customers, results in need to add more cashiers and additional check-out stands.

Processing a coupon is only the beginning of a series of costly events for retailers. Once a discount is made on a product for a coupon, the retailer has a comparatively large investment which must be recouped. Most often, the discount realized by using a coupon to purchase a product is significantly greater than a margin or retail mark-up on the product. For the sale to be profitable, the value of the coupon must be recouped from an issuer of the coupon. Since more than one manufacturer commonly issues coupons which are processed daily, processed coupons must be saved, collected, sorted and carefully and properly submitted to appropriate manufacturers for reimbursement. This process represents both a lag, representing a continual investment by a retailer, and a cost. To defray the cost, it is standard practice for each manufacturer to add a handling fee to the reimbursed amount. However, the reimbursement fee is nominal, e.g. it is currently common to provide an additional for each successfully submitted and processed coupon.

As a result, companies have been created for the specific purpose of processing coupons for retailers, performing services of sorting coupons and billing manufacturers (publishers of coupons) and expediting reimbursements. An example of such a company is Grocers Coupon Services, 110 Stark Street, Manchester, N.H. 03101. In an Internet mailer, Grocers Coupon Services report that over 273.4 billion coupons are distributed annually (over 3,000 per U.S. Household) and the number is increasing. Grocers Coupon Services and other like companies offer to sort, count and redeem coupons for retailers. Services are offered by such companies to retailers for a portion of the additional reimbursement fee. These services often include assurances of reimbursement within three to four weeks rather than longer times taken by some individual manufacturers and/or coupon processing arms of the manufacturers.

More advanced checkout processes, such as self checking by customers, may also exacerbate coupon handling. Complexities of processing coupons, for example those which are out-dated, may cause an inordinate delay by cashiers who may be called upon to service more than one self-service checkout line at one time.

There are other redemption processes which are also time consuming and, for that reason, likely result in lower than desired incremental sales increase success rates because of inefficiencies of current practices. Such processes include product rebate and contest entry practices. Both of these processes are usually associated with a product purchase and require validation of the purchase. Ofttimes these processes are sufficiently cumbersome and confusing to discourage some proportion of potential participators in these redemption processes and perhaps in purchasing an associated product at all.

Definition of Terms

Devices and processes associated with the Internet have been given acronyms and abbreviations which are becoming commonly used. In the interest of communicating with standard terminology the following terms, some of which are uniquely defined herein and others of which are found U.S. Pat. Nos. 5,708,780, 5,724,510, 6,006,268 and 6,012,088, are defined as follows:

| | |
|---|---|
| Browser | A form of user software used to provide |
| | access and, for a coupon processing station, |
| | to display pages of coupon images as well as |
| | other coupon processing station activities. |
| c | A subscript identifier for each coupon |
| | originator. |
| Consumer | A customer at a commercial establishment |
| | wherein a coupon processing station is |
| | installed. |
| Controller | A central communications and control computer |
| | which links with an in-establishment, |
| | remotely disposed coupon processing system. |
| CO | Coupon Originator, usually a manufacturer who |
| | issues a coupon as a sales incentive for a |
| | product. |
| CPL | An acronym for a coupon purchasing list |
| | issued by a coupon processing station or over |
| | the Internet for printing by a personal |
| | computer. |
| CPLI | An acronym for a coupon purchasing list. |
| | identifier, which is generally machine |
| | readable indicia such as a bar code. |
| CPSF | an abbreviation of coupon parameter storage |
| | file, a file in which coupon parameters, such |
| | as coupon value, bar code identifier and |
| | expiration date are stored for reference. |
| CPU | An acronym for central processing unit. A |
| | CPU is a digital computer which may be a |
| | personal computer, a large computer or any |
| | other computer used to service computational, |
| | digital control or storage needs in a digital |
| | system. |
| Digital | A key to starting an SSL procedure, each |
| certificate | digital certificate is generally issued by a |
| | Certificate Authority which amounts to |
| | issuing a public key exchange. |
| e | A subscript used to identify an individual |
| | check-stand in an establishment. |
| Ethernet | Ethernet is a widely used local area |
| | networking (LAN) technology. It is reported |
| | that millions of ethernet network interface |
| | cards (NICs), repeater ports, and switching |
| | hub ports have been sold in a market which |
| | continues to grow. |
| FTP | File Transfer Protocol |
| HTML | Hypertext Markup Language a language for |
| | formatting Internet transmitted pages, HTML |
| | includes standard text as well as formatting |
| | codes. |
| HTTP | Hypertext Transfer Protocol a protocol |
| | designed to run primarily over TCP/IP using |
| | standard Internet setup. |
| I/O | Input/output, usually references buses or |
| | devices which process data bidirectionally. |
| Internet | This term (with upper case “I”) refers to |
| | that particular global communications network |
| | that is in use around the world. |
| j | a subscript used as a pointer for a unique |
| | shopping list identifier |
| k | a subscript used to identify an individual |
| | coupon file. |
| Key | An encryption access code for a transmitted |
| | file. |
| Kiosk | A stand-alone customer service booth which, |
| | for the instant invention, is understood to |
| | be a coupon processing station. |
| LAN | Local area network |
| n | a subscript used to identify booths in a |
| | coupon processing station |
| p | a subscript used to reference personal |
| | computers (PC's) which communicate with a |
| | central controller for the purpose of |
| | preparing computer lists at the PC. |
| PGP | A trade-mark for a powerful cryptographic |
| | product family that enables secure and |
| | private transmission of messages over the |
| | Internet. PGP utilizes public/private key |
| | encryption and decryption processes. |
| Private key | A portion of an encryption code which is |
| | complementary to a given public key, and is |
| | the only key which may be used to decrypt |
| | information encrypted with the given public |
| | key, such a combination is commonly |
| | referenced as a public/private key |
| | combination. |
| s | a subscript used to identify a coupon |
| | processing system in an establishment which |
| | is remote from a centrally disposed |
| | controller. |
| Server | A server is a computer connected to a network |
| | via a network interface card and is |
| | programmed to act as a traffic manager and |
| | storage device for data being transmitted |
| | over the network by various connected nodes. |
| SSL | An abbreviation for “Secure Sockets Layer”, a |
| | name associated with securely tunneling or |
| | passing information over the Internet. |
| XML | Extensible Markup Language (Internet |
| | standard). |

### BRIEF SUMMARY AND OBJECTS OF THE INVENTION

In brief summary, this novel invention alleviates all of the known problems related to handling and redeeming coupons by retail establishments. The invention comprises a coupon processing station, commonly referenced to herein as a coupon kiosk, which is disposed within a retail establishment. The coupon kiosk is situated to be readily available to customer traffic. One or more customer service bays on the coupon kiosk are disposed for easy access and self-service operation.

The coupon kiosk provides a reader into which a coupon is inserted and whereby identifying indicia disposed on each coupon is read and processed. Information stored within the coupon kiosk is used to verify that the coupon may be redeemed in the retail establishment. Once verified, the coupon is ingested into the kiosk, to be stored and kept from being used again. The coupon may also be marked or mutilated in some manner to preclude reuse.

In addition, the kiosk has a programmable display which is a part of the computer system for communicating instructions and other information to a user of the kiosk. The display may be a flat panel display with a touch screen, which provides a simple, easy to learn operational interface. Via the display, pictorial images of coupons, which are available from memory in a digital processor within the kiosk and which may be redeemed by purchase of products in the establishment, are alternatively made available to the user. A coupon browser facilitates and limits display of only those product areas of interest to the viewer. In this manner, coupons may also be selected for redemption through the interface, such as by touching a pictorial image of a coupon displayed on the screen.

The coupon kiosk system also has a printer. Once one or more coupons have been processed as candidates for redemption via the coupon kiosk and the user selects an operator which terminates the coupon selection process, a list of the preselected coupons is printed and provided as a coupon shopping list. The coupon shopping list has a machine readable identifier, such as a bar code, which permits automatically identifiable data to be read and entered into a check-stand bar code reader. Each panel display and associated touch screen on the kiosk operates independently, allowing a plurality of users at the kiosk simultaneously.

As it is anticipated that not all of the screens on a kiosk will be in service all of the time, when not in use, the programmable displays may be alternatively used to show product advertising, in-store events, weather information or other programmably controlled video sequences which are eye catching and attractive to a customer. To assure attentive operation as a user approaches, the kiosk system may have a motion detector which changes a mode of kiosk display operation from alternative displays to responsive coupon programming when motion is detected.

In addition to the coupon kiosk, the invention comprises a central communications and control computer, generally referenced as a controller herein, and an establishment communications link, generally referenced as a list insertion hub. The list insertion hub is also a digital processor based system which under predetermined conditions receives coupon codes from the kiosk computer and delivers those coupon codes to the establishment computer for use in preparing a customer receipt with appropriate computer redemption values calculated and imprinted thereon. In some installations, the kiosk computer and the list insertion hub may utilize the same digital processor (i.e. computer).

Generally, the list insertion hub provides an interface with the establishment computer for timely transfer of coupon identifying indicia (contemporarily being bar codes) to the establishment computer. However, an important function of the invention is verification of proper coupon use to guard against misredemption. For this reason, the list insertion hub monitors product sales from each cash register and matches products purchased against coupons recorded on the coupon list before transferring the identifying indicia of redeemed coupons to the establishment computer. In this manner, only bar codes of those coupons which are listed on the coupon list and for which products have been purchased are transferred to the establishment computer. Thereby, a record is made within the list insertion hub computer of all coupons for which a remittance is due to the establishment.

Within the scope of the invention, a coupon may still be processed, as currently done, by submission of the coupon at a check-out stand at time of purchase. Note, that the record made of all bar codes read at a check-stand permits the coupon to be redeemed at the check-out stand without being processed through the coupon kiosk. After collection of such a coupon at the check-out stand, management of the store may elect to process the coupon via the coupon kiosk so that reimbursement for that coupon may be included with reimbursement for coupons otherwise processed through the kiosk.

Such reimbursement is an inherent attribute of the invention. Based upon purchase verification of coupons processed through the kiosk and/or list insertion hub, records of validated coupons are sorted by CO with associated billings assembled and, as appropriate, applications for rebate are made via the controller. Note that such verification and billings require secure operation and communications. For this purpose, communications among the controller, coupon kiosk and list insertion hub are protected by secure encryption processes.

The controller sends all forms of CO coupon images necessary for displaying coupon images, data initiating and rescinding coupons which may be validated at a kiosk, advertising media, updates on alternative attractions (such as weather information), and other controls and communications used in kiosk interactive operation with the establishment. Generally, all CO coupons for which reimbursement is available through the kiosk and controller are verified via the controller. By placing redemption verification within the control of the controller, assurance of proper redemption practices (e.g. proper purchase requirements for each redeemed coupon being met) are assured. The controller, by design, is generally remote from retail establishments and, therefore, communicates by direct line or wireless links with the coupon kiosk and list insertion hub computers.

It is recognized that the process of publishing coupons not only represents a profound fiscal responsibility for a CO, but also a ready insight to precious marketing campaign information. Within the scope of the instant invention, a CO, a manufacturer or other product distribution agent who originates and/or has responsibility for reimbursement, is provided control and secure confidentiality for all coupons and associated coupon parameters to be released by the CO. Each CO may have access to the controller through one or more computers having Internet links and associated Internet browsers. Such coupons may be provided to the controller via standard coupon publishing procedures; however, it is anticipated that each CO may periodically provide coupons, associated coupon parameters and other advertising files to the controller over the Internet. Such communications may involve transmission of applets, plug-ins and other software programs necessary for reconfiguring each kiosk based browser as necessary for providing predetermined display of coupon and advertising information on kiosk displays. For these purposes coupon originators may be provided with encrypting programs which permit selective encryption of all such coupon related files generated on each individual Co.

All files sent for storage on a controller server are encrypted such that only the authoring CO may have access to information contained in the courses prior to release for publication and no other person, including personnel at the server site, has access to such course information. In this manner, server operating personnel are relieved of pressures of unauthorized access to server based information, permitting the server to provide service to competitive clients.

Release for publication of each coupon and other related information to be offered through kiosks is accomplished by passing a decryption key to the server. In this manner, publication and distribution can only be published over the Internet by the responsible Co. Of course, the server comprises software to decrypt coupon files after receiving encryption keys from the authoring CO.

As an alternative service, the controller may act as a more broadly based Internet server and provide coupon shopping list generating programs directly to a user over the Internet. Such a list may be assembled via the Internet on a personal computer (PC) and a coupon shopping list printed thereby. Such a coupon shopping list may be either taken to and used at a store selected from a list available on the Internet. Alternatively, an Internet user may be identified by the Internet program and elect to have a shopping list stored on the controller for future access. On arrival at a store, the Internet user uses a kiosk to down load the controller stored coupon shopping list by entering personal identification (such as swiping a credit card) and selecting a controller stored shopping list routine. In any event, Internet communications are an alternate mode of generating and communicating coupon codes for use in coupon use and validation in retail establishments.

The kiosk computer system and list insertion hub computer system cooperatively send coupon related data to the controller. Such data includes, but is not restricted to, remittance requests for redeemed coupons for verified coupon use at the establishment. Other information which might be sent includes a report on coupons selected for use on a kiosk, but not redeemed by purchase of related products. Upon receipt of each remittance request, action is taken by the controller to acquire a remittance for the establishment. If the kiosk computer system and list insertion hub computer system do not employ the same computer, communication between the computer systems is preferably via wireless phone links.

As a further incentive for installing a kiosk in an establishment, the coupon system provides for locally generated coupons and advertising to be added to the coupon list, either via browsing or as an unrequested addition. Other potential alternative uses of the kiosk are for preverification of credit card identification and data to be transferred to the establishment computer along with redeemed coupon information. For this purpose, the kiosk computer system may include a credit card reader or the like. Another use of the coupon kiosk may be application for rebates and contest entries. Both of these uses may be facilitated by use of the credit card reader.

Accordingly, it is a primary object to provide a self-service coupon processing system disposed in a retail establishment.

It is another primary object to provide a coupon processing station which generates a coupon shopping list and store coupon identifying indicia for coupons on that list in the coupon processing system.

It is a basic object to provide a printed shopping list having unique machine readable indicia thereon.

It is another basic object to provide a list insertion hub which validates product sales transactions at time of purchase against purchase conditions associated with coupon items listed on the coupon shopping list.

It is a fundamental object to provide a communications link from the list insertion hub for communicating identifying indicia for coupons associated with validated product sales transactions to a store computer such that coupon redemption may be made part of an associated purchase transaction.

It is an object to provide a communications link having Ethernet interconnections with in-establishment cash register related data communications systems.

It is an object to provide a switching hub for interconnecting cash register communications with existing retail establishment computer systems.

It is an important object to provide a list insertion hub which assembles a list of redeemed coupons for use in recovering costs of coupon redemption and other costs related to coupon processing.

It is also an important object to provide a mode of operation within the list insertion hub which sorts the assembled list so that those responsible as coupon originators may be billed for refunds.

It is a consequential object to provide a coupon processing station which has operational modes of providing consumer communications and generating and printing coupon shopping lists.

It is another consequential object to provide a coupon processing station which generates and prints a uniquely identifiable, machine-readable code which is affixed to the coupon shopping list.

It is an object to provide a central controller, remotely disposed relative to at least one in-establishment coupon processing system, which collects coupon redemption data of validated coupon transactions from each at least one in-establishment coupon processing system and transmits billings to companies and individuals responsible for coupon redemption.

It is an object to provide a central controller having encryption and decryption communications processing whereby transmission to and from each coupon processing station and each coupon originator is secure.

It is an object to provide a coupon processing station having a video display and associated digital entry facility for displaying and selecting coupons from images and other identifiers stored within the coupon processing station.

It is an object to provide a coupon processing station having a touch screen panel display.

It is an object to provide a coupon processing station having a magnetic strip reader whereby credit card data and the like may be read for user identification purposes into a digital processor of the coupon processing station.

It is an object to provide a coupon processing station and a list insertion hub with an intercommunication link whereby digital data is bidirectionally transmitted.

It is an object to provide an intercommunication link comprising a wireless modality.

It is an object to provide a coupon processing station having multi-mode capability such that coupon processing and other related activity occurs while a user is interfacing with the station and a controller generated video display activity (e.g. product advertising, in-establishment advertising, weather, etc.) when an operational side of the station is vacant.

It is an object to provide a list insertion hub which filters data sent from cash registers to an associated in-store computer.

It is an object to provide coupon list generation and associated coupon processing via the Internet.

These and other objects and features of the present invention will be apparent from the detailed description taken with reference to accompanying drawings.

### BRIEF DESCRIPTION OF THE DRAWINGS

FIG. 1 is a perspective of a coupon processing station according to the instant invention.

FIG. 2 is a frontal elevation of one booth of the coupon processing station seen in FIG. 1.

FIG. 3 is a schematic diagram of an exemplary coupon processing system which is seen, in this example, to include a central controller subsystem and three coupon processing subsystems, each disposed in a separate remote establishment.

FIG. 4 is a schematic of the central controller seen in FIG. 3. FIG. 5 is a schematic of the coupon processing subsystem seen in FIG. 3.

FIG. 6 is a block diagram representation of electronic portions of the coupon processing station of FIGS. 1 and 2.

FIG. 7 is a top elevation section taken along lines 7-7 of the coupon processing station seen in FIGS. 1.

FIG. 8 is a coupon shopping list printed by the coupon processing stations seen in FIGS. 1, 2, 6 and 7.

FIG. 9 is a coupon shopping list similar to the coupon shopping list seen in FIG. 8, but with two bar codes imprinted thereon.

FIG. 10 is a block diagram representation of a bar code field as utilized on the shopping lists seen in FIGS. 8 and 9.

FIG. 11 is a program flow chart of an initialization routine for the electronics of the coupon processing station seen 20 in FIG. 6.

FIG. 12 is a program flow chart showing a main loop continuation from FIG. 11.

FIG. 13 is a program flow chart showing responsive program flow to motion detected in the program flow chart of FIG. 12.

FIG. 14 is a program flow chart showing off-line program flow when no motion is detected in program flow chart 12.

FIG. 15 is a program flow chart showing program flow response associated with communication between the coupon processing station and a list insertion hub which are parts of the coupon processing subsystem seen in FIG. 5.

FIG. 16 is a schematic block diagram of a list insertion hub.

FIG. 17 is a symbolic drawing which represents a check stand which is well known in the retail merchandising art.

FIG. 18 is a symbolic drawing which represents a retail establishment transaction processing computer, such computers being in common use.

FIG. 19 is a symbol for a repeater as commonly referenced in ethernet literature.

FIG. 20 is a schematic block diagram of a communication system between check-stand components and a retail transaction processing computer.

FIG. 21 is a schematic block diagram of a communication system as seen in FIG. 20 with a list insertion hub interposed between the check stand components and retail transaction processing computer.

FIG. 22 is a schematic block diagram of an ethernet based communication system connecting communicating check-stand components with a retail transaction processing computer.

FIG. 23 is a schematic block diagram of an ethernet system as seen in FIG. 22 with a list insertion hub interposed between the check stand components and retail transaction processing computer.

FIG. 24 is a schematic block diagram of an ethernet system as seen in FIG. 22 with a list insertion hub affixed via a repeater to the ethernet system.

FIG. 25 is a block diagram of a combined coupon processing station and a list insertion hub as a single unit.

FIG. 26 is a program flow chart for a list insertion hub system boot routine.

FIG. 27 is a program flow chart which continues from FIG. 26 for a primary or main operating loop for a list insertion hub.

FIG. 28 is a program flow chart flowing from FIG. 27 for long distance communicating operation of the list insertion hub.

FIG. 29 is a program flow chart flowing from FIG. 28 for communicating new coupon and offline files from a central controller to the list insertion hub.

FIG. 30 is a program flow chart flowing from FIG. 28 for uploading validated coupon and other files from the list insertion hub to the central controller.

FIG. 31 is a program flow chart flowing from FIG. 28 for acquiring a coupon shopping list by the list insertion hub from the central controller.

FIG. 32 is a program flow chart flowing from FIG. 28 for acquiring bar codes and coupon shopping lists not stored in the list insertion hub from the central computer.

FIG. 33 is a flow chart flowing from FIG. 27 depicting program flow within the list insertion hub for communicating with a coupon processing station.

FIG. 34 is a program flow chart flowing from FIG. 33 for communicating new files from the list insertion hub to the coupon processing station.

FIG. 35 is a flow chart flowing from FIG. 33 for programming the list insertion hub to receive coupon shopping lists from the coupon processing station.

FIG. 36 is a list insertion hub flow chart for responding to requests from the coupon processing station for programming rain check and coupon bar codes.

FIG. 37 is a program flow chart flowing from FIG. 33 for processing an alarm signal from the coupon processing station.

FIG. 38 is a flow chart flowing from FIG. 27 for programming data packet interpretations flowing from a check stand and the list insertion hub.

FIG. 39 is a program flow chart flowing from FIG. 38 for accumulating purchases during check-out for future validation of items printed on a coupon purchasing list.

FIG. 40 is a program flow chart flowing from FIG. 38 for storing coupon purchasing list indicia into the list insertion hub.

FIG. 41 is a program flow chart flowing from FIG. 38 for communicating validated coupon bar codes to a store computer and completing the transaction upon receipt of a “total” signal from the check-stand completing check-out.

FIG. 42 is a program flow chart flowing from FIG. 27 for programming the list insertion hub to receive and process in-store coupons and advertising.

FIG. 43 is a program flow chart of a portion of a main loop program which applies to a central controller of the instant invention.

FIG. 44 is a program flow chart flowing from FIG. 43 for responding to a request for a bar code by a list insertion hub.

FIG. 45 is a program flow chart flowing from FIG. 43 for polling list insertion hubs for controlled communication between individual list insertion hubs and the central controller.

FIG. 46 is a program flow chart flowing from FIG. 43 for acquiring, creating and amending files of coupon parameters.

FIG. 47 is a program flow chart flowing from FIG. 43 for processing coupon shopping lists acquired from a remote personal computer (PC) and for either storing or transmitting that each acquired shopping list to a predetermined list insertion hub.

FIG. 48 is a program flow chart flowing from FIG. 43 for creating and sending billings for validated coupons to coupon originators for payment.

FIG. 49 is a block diagram wherein communications between a central controller according to the instant invention is seen to communicate with coupon originators, individual personal computers and coupon processing subsystems.

### DETAILED DESCRIPTION OF THE ILLUSTRATED EMBODIMENTS

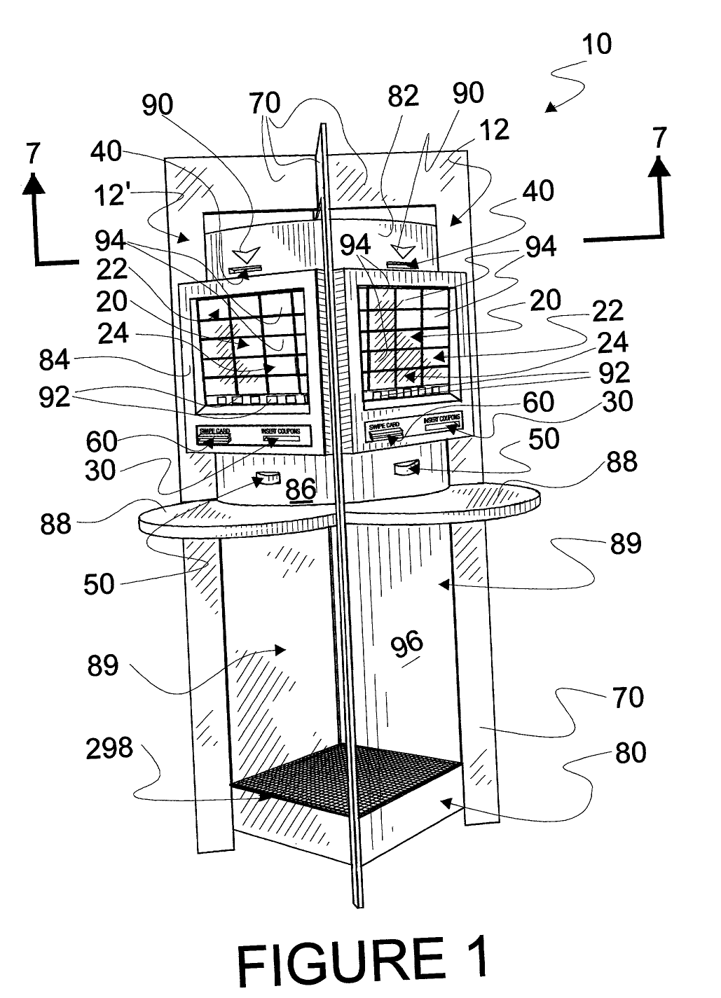

Reference is now made to FIGS. 1-49, wherein like numerals are used to designate like parts throughout. Where parts are different, but similar in form and function, so related parts are designated by numerals and primes of those numerals. In cases where greater numbers of parts are referenced than can be designated by numerals and primes, alphabetical suffixes are applied to like numerals.

The order of elements basic to the instant invention disclosed herein is:

1. A coupon processing station (or kiosk) which compiles a shopping list and a shopping list file from coupons inserted into a coupon bar code reader and from coupons selected from coupon images displayed by the kiosk. The shopping list is printed with a single identifier which is automatically read at a check-stand of an establishment, wherein the kiosk is disposed, for redemption of one or more coupons, thereby. The shopping list file is communicated to a list insertion hub for use in validating purchases related to coupons on the shopping list.

2. The list insertion hub, which receives all coupon shopping list files from the kiosk, makes a record of sales at each check-stand and receives a read-out of the coupon shopping list identifier as a part of a purchase transaction at each check-stand. Using the list identifier, the so identified coupon shopping list file is retrieved and purchases for which coupons may be redeemed are verified and the associated coupons are validated for redemption. Bar code identifiers of validated coupons are communicated to the store computer associated with the check-stand for appropriate savings to be applied to the purchase price total of the purchase transaction. Validated coupons are recorded and sorted into files for later communication to a central controller.

3. The central controller serves a plurality of kiosks and list insertion hubs, receiving validated coupon files from each establishment and compiles billings to responsible coupon originators for appropriate remuneration to each establishment in which coupons have been so redeemed and validated. In addition, the central controller establishes criteria for all coupon processing by kiosks and list insertion hubs and schedules paid advertising and other displays. Such advertising and other displays are scheduled for interim periods between uses of the coupon processing station as a coupon shopping list provider.

Coupon Processing Station and Coupon Shopping List Generation

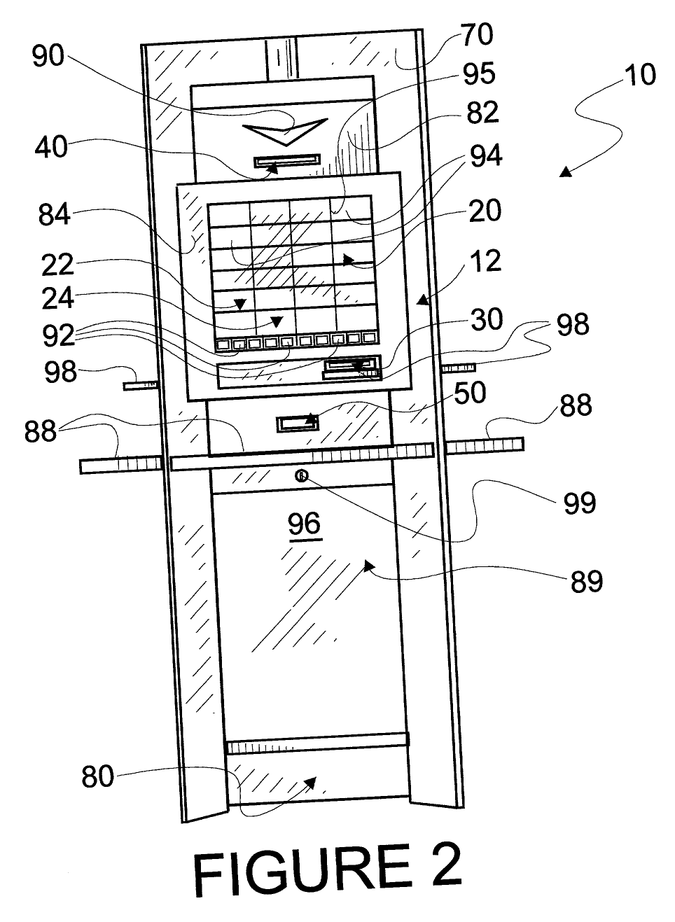

A coupon processing station, otherwise referenced herein as a coupon kiosk and generally designated 10, is seen in FIGS. 1 and 2. Generally, station 10 comprises at least one graphics display screen with an associated touch panel, although other 20 methods of selecting items displayed on the graphics display may be used within the scope of the instant invention, e.g. a mouse. An example of such a combination is seen as flat LCD screen and touch panel 20 seen in each of two operating booths (designated 12 and 12′) of station 10 in FIG. 1 and seen in a single booth 12 in FIG. 2. Hereafter, the display or screen portion of flat LCD screen and touch panel 20 will be referenced as screen 22 while the touch panel portion will be referenced as panel 24.

Note that booths 12 and 121 are substantially the same, however, each such booth may be used separately. Such a touch LCD flat panel 20 may be a 15 inch MTK1500 panel mount from Touch Screens Inc., www.touchwindow.com, but many display and touch panel combinations are available in contemporary commerce. Types of touch screens which may be considered are those which are activated by resistive response to touch, acoustic wave absorption and capacitive sensing of human body electricity. While capacitive touch screens or panels may have greater durability, resistive panels may have better overall sensitivity to a wider range of input parameters, such as those associated with gloved fingers.

Each booth (12,12′) of station 10 is further seen to comprise a slot 30, inferiorly disposed relative to screen and panel 20, wherein coupons are inserted for processing, and a slot 40, superiorly disposed relative to screen and panel 20, from which a printed coupon shopping list is delivered to an operator of station 10. For ease of manufacture, station 10 may comprise but one slot 40 and a printing drum which is rotated to dispense coupon shopping lists serially to one booth (e.g. 12 or 12′) at a time, as is disclosed in detail hereafter. Also seen in each booth 12,12′, etc. of station 10 in FIG. 1 is a motion detector 50 and a magnetic stripe reader 60, each being inferiorly disposed relative to screen and panel 20.

Mechanically station 10 is supported by four upright supporting members, generally numbered 70, which also provide privacy shields between booths. A base member 80 is weighted and disposed inferiorly to provide stability for station 10. In combination, a drum 82, which houses printer slots 40, a plurality of frames (generally numbered 84), in each of which an LCD screen and touch panel 20 is mounted, a second drum 86, in which each motion detector 50 is disposed, a convenience shelf 88 and four walls (generally number 89), are disposed between supporting members 70 on each side of station 10 to securely enclose station 10 to provide a stand-alone kiosk.

Note that drum 82 has eye-catching indicia 90 disposed above each slot 40 to draw attention to the site from which a coupon shopping list will be provided. Of course, visual messages which range from printed instructions to presentation of coupon images are among the information provided on screen 22. In addition, a series of keyboard functions may be initiated by access to a series of buttons, generally designated as 92, disposed at the bottom of screen and panel 20. While hard switches may be employed in toto or in part for buttons 92, it is preferred that buttons 92 be formed as soft keys which are a part of screen and panel 20 operation. It may be noted that the image portrayed on each screen 22, in FIGS. 1 and 2, is divided into a plurality of sections, generally numbered 94. Such is indicative of a coupon image matrix wherein a coupon image may be displayed in a predetermined section, such as section 94 which is bounded by lines 95 (see FIG. 2), which set the coupon image apart, for selection by touch as disclosed in detail hereafter.

Convenience shelf 88 is inferiorly disposed relative to slot 30 to provide a counter for purses and other coupon carrying paraphernalia during use of station 10. Inferiorly disposed relative to shelf 88 is an enclosure 96 formed by walls 89 into which coupons inserted into slot 30 and accepted for inclusion on a coupon shopping list are cached upon ingestion into station 10.

As is seen in FIG. 2, another shelf 98 may be inferiorly disposed relative to slot 30 to aid in inserting a coupon or other paper to be read into slot 30. Also, evident in FIG. 2 is a key lock 99 which is used to secure, yet provide entry to enclosure 96 via a removable panel 89 for selected access to ingested coupons.

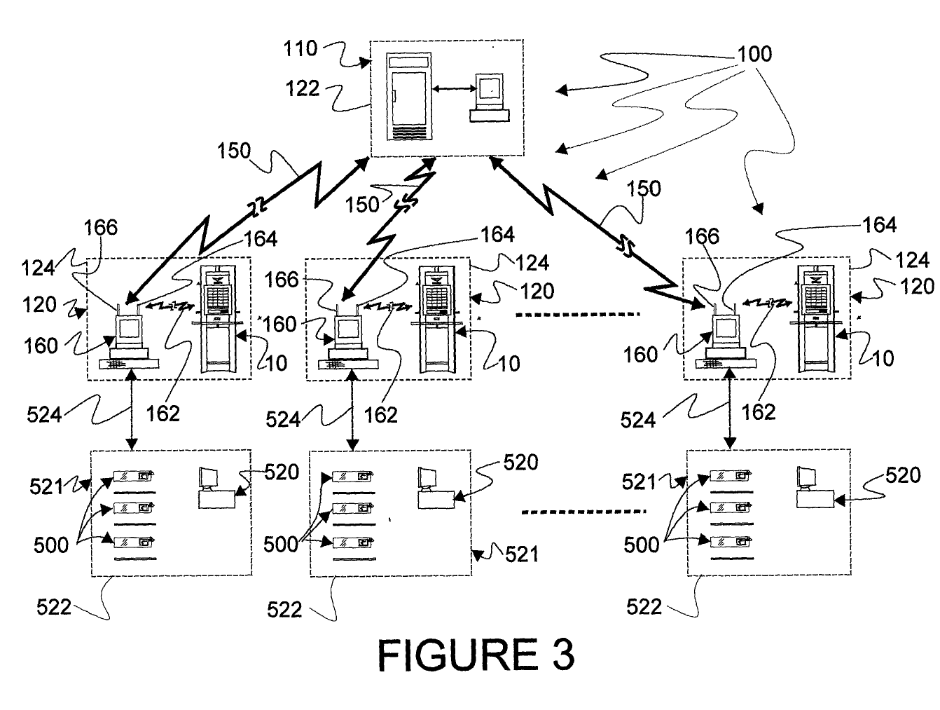

Reference is now made to FIG. 3, wherein a system 100 according to the instant invention, is seen to be comprised of at least two types of subsystems, a controlling computer subsystem (generally designated controller 110) and, an in-establishment coupon processing subsystem, generally designated 120. Note, as is generally the case, one controller 110 will service a plurality of in-establishment processing subsystems, each numbered 120. For clarity, subsystem 110 is enclosed by dashed lines 122 and each coupon processing subsystem 120 is enclosed by dashed lines 124.

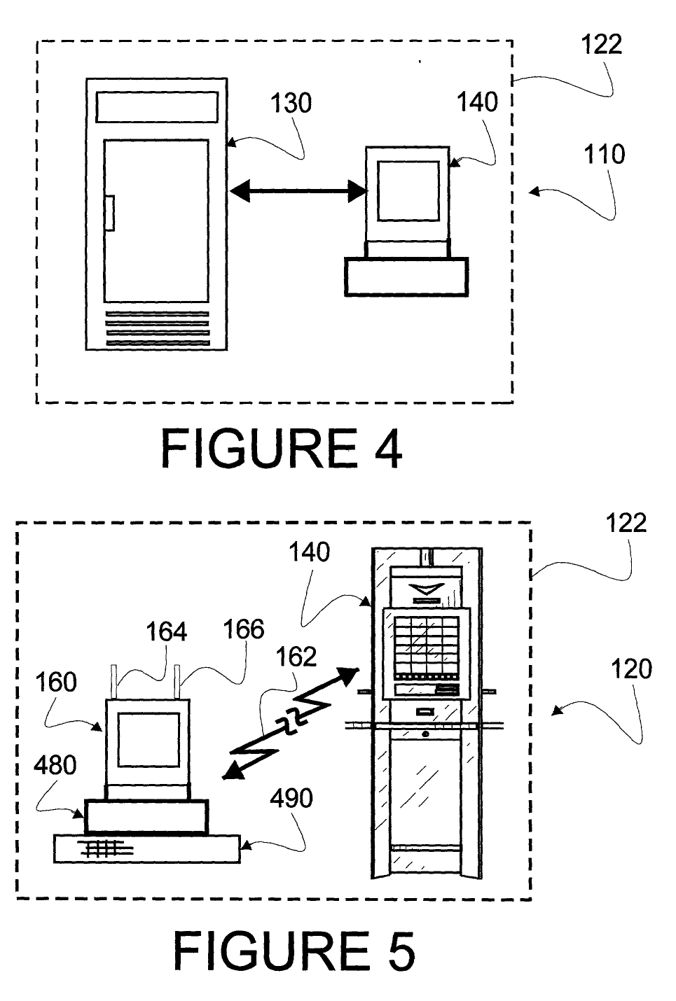

Each processing subsystem 120, during normal use, is remotely disposed (e.g. in a retail establishment) relative to controller 110. As may be better seen in FIG. 4, controlling subsystem 110 comprises a server 130 and a system control computer 140. Generally, as is true of most servers, server 130 communicates with each subsystem 120 over an Internet, RF or other communication link.

Remotely generated CO information that is to be utilized in each coupon processing station 10 is first organized and stored in server 130 of controller 110. Such information is typically coupon images and advertising, which may be in the form of graphics files, video files, audio files and HTML/XML files. 15=HTML files are generally programs which when downloaded to a coupon processing station 10 controls operation, sequencing, timing and overall functioning of the receiving station 10. Graphics files, video files, audio files and transmission of written information is readily controlled and sequenced to produce effective media advertising through the use of standard HTML/XML programs for controlling Internet Browser applications, which run on coupon processing station 10.

One skilled in the Internet art well understands generation, organization and transmission of such applications. Though not necessary within the scope of the instant invention, use of browser based programs, common to web based programming, is an effective method of programming and controlling sequencing of coupon processing station 10.

Files are readily downloaded to each in-establishment subsystem 120 from controller 110 via a phone link, generally numbered 150 (see FIG. 3). In like manner, other files may be readily uploaded from an in-establishment subsystem 120 to controller subsystem 110. Phone links 150 may be made via wired (e.g. phone line) or wireless (e.g. cell phone) transmissions. As disclosed in detail hereafter, subsystem 120 is computer based. As such, a standard file transfer protocol (FTP) application on both the system control computer 140 and all computers housed within each in-establishment subsystem 120 permit a controller 110 operator to manually or automatically send and receive files.

Of special consequence is a status file transmitted from each particular in-establishment subsystem 120 to controller subsystem 110. The status file transmits critical status records and processing reports of the particular subsystem 120. Such records may include, but are not restricted to, coupon processing data and system status including printer paper remaining, subsystem test and memory test results, and other maintenance related information. Elements of these records and processing reports are discussed in more detail hereafter.

Controller subsystem 110 comprises parts which are well known and in wide use in Internet applications. Control computer 140 performs as a system control computer which, for example, may employ a Windows Operating System. Server 130 serves as a database server system and may employ operating system Windows NT with SQL database system.

In-establishment subsystem 120 comprises at least one coupon processing station 10, as seen in FIGS. 1 and 2, and a list insertion hub 160, as seen in FIGS. 3 and 5. While station 10 and insertion hub 160 may be housed in a common chassis and use one common microprocessor, physical facilities of establishments where subsystem 120 is installed may more often dictate that station 10 and insertion hub 160 be separate units. In such a case, as seen in FIG. 5, insertion hub 160 communicates with station 10 over a local digital communication link as indicated by each communication line 162. Such a line 162 is generally over local, short-range wireless communications which are well known in contemporary communications art. Each insertion hub 160 also serves as the prime communications link with subsystem 110 over a line 150 (see FIG. 3).

Insertion hub 160 is seen, in FIG. 5, to comprise a pair of antennas, 164 and 166, for local and long distance wireless communications, respectively. Other elements of insertion hub 160 are disclosed in further detail hereafter.

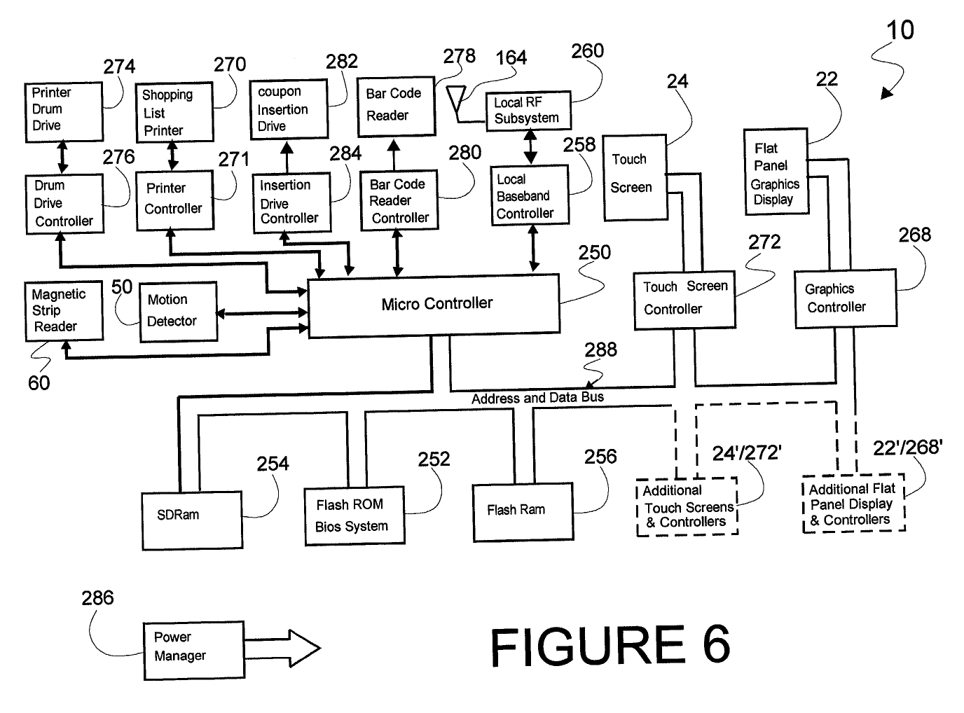

Station 10 comprises a number of functional subassemblies as seen in FIG. 6. Basic subassemblies of station 10 are a micro controller 250; memory modules including a flash ROM bios system 252, SDRam module 254 and flash RAM module 256; a local baseband controller 258 and associated RF subsystem 260 with antenna 164;

a motion detector 50; at least one LCD screen 22; associated graphics controller 268; a touch panel 24 and associated controller 272; a printer 270 and associated printer controller 271 for producing a coupon shopping list; a printer drum drive 274 and drum drive controller 276; a bar code reader 278 and bar code reader controller 280; a coupon insertion drive 282 and insertion drive controller 284 and a power manager module 286. A power source for power manager 286 should be made available from establishment power. Other augmenting subassemblies which may be profitably utilized are a magnetic strip reader 60 (seen FIGS. 1 and 6) and video camera and a speaker, not seen in the Figures.

These augmenting subassemblies are considered potentially valuable but accessorial in nature.

Microprocessor 250 must be capable of not only communicating over subsystem 260, printing coupon lists via printer 270, providing timely display over a graphics display 22 and process inputs through touch screen 24, but also to service additional (up to three) additional touch and graphics screens as indicated by dashed line subassemblies 24′/272′ and 22′/268′, respectively. To meet such requirements, an Intel StrongARM SA-1110 which is a high-performance, low-power processor for portable wireless multi-media devices may be used for micro controller 250. The StrongARM SA-1110 is a 32-bit processor that incorporates Intel design and process technology. Memory control of the SA-1110 supports SDRAM, ROM, flash RAM and other types of memory. As an example, SDRAM module 254, flash ROM 252 and flash RAM module 256 are interfaced with micro controller 250.

In the case of the StrongARM SA-1110, Windows CE is currently the operating system of choice, including applications for Windows media player version 7.1 or higher, pocket Internet explorer browser and FTP data transfer. Flash ROM 252 is programmed with Bios to start the CE operating system and to run selected startup application programs.

As is well known in the computer art, Windows CE operating system description is a modular real-time embedded operating system for small footprint and mobile 32-bit intelligent and connected devices. Windows CE combines Windows compatibility and advanced application services with support for multiple CPU architectures and built-in networking and communications options to deliver a rich, scalable, open foundation for building a wide variety of products. Windows CE powers consumer electronic devices, Web terminals, Internet access appliances, specialized industrial controllers, mobile data acquisition handheld and embedded communication devices. As a highly modular platform, Windows CE allows a developer to flexibly and reliably build new generations of small footprint and mobile 32-bit devices that integrate seamlessly with Windows and wireless applications.

Graphics controller 268 may be an MQ-1132 unit from MediaQ. The MQ-1132 is an integrated LCD and peripheral controller with embedded memory for portable devices requiring high performance. As such, graphics controller 268 readily interfaces with the Intel SA-1110 microprocessor of micro controller 250. In addition, software using the media player facilely accesses with the MQ-1132 of graphics controller 268 to play video multimedia. Further the MQ-1132 is easily interfaced to many different sizes and formats of LCD screens. LCD screen 22 may be 15 inch MTK1500 panel mount from Touch Screens Inc., www.touchwindow.com. Of course, other display and touch panel modules with different sized displays may be used within the scope of the present invention to provide a variety of coupon display sizes and resolutions as well as other screen based communications. Touch screen 22 may be an add-on monitor such as that provided by earthLCD.com or hantouch.com. Of course there are many integrated touch flat panel systems which may be used as well. Most touch panel interfaces are compatible with standard mouse interfaces.

As seen in FIG. 1, more than one LCD display may be used in coupon processing station 10. As a point of fact, it is more likely that four screens will commonly be used so that a four sided kiosk 10 may be used to alleviate delays and associated consumer lines. For such a purpose, address and data bus 288 may connect to additional touch and graphics screens and associated controllers, 24′/272′ and 22′/268′, respectively.

It is very important to fully utilize the display capability of station 10. For this purpose, one motion detector 50 is directed orthogonally away from each particular screen and panel 20 to detect motion related to that particular display. As an example, when no one is within a predetermined distance (e.g. 10 feet) of coupon processing station 10, as sensed by a detector 50 after generation of a coupon shopping list, mode of operation of the screen and panel 20 which is associated with a particular detector 50 is changed from coupon selection and coupon list generation to more general displays, such as paid (or offline) advertising. Upon detection of motion by a detector 50, a signal to micro controller 250 returns operation of the associated screen and panel 20 to an interactive coupon processing mode.

Within the scope of the instant invention, motion may be detected via many methods, including those which employ photo detectors, ultrasound devices and video cameras. However, the method selected employs a passive infrared detector which provides a low cost detection system to constantly monitor for motion in proximity to an associated booth 12, 12′, etc. For this purpose, an Ademco Sensor Company 998PI may be interfaced to the StrongARM SA-1110.

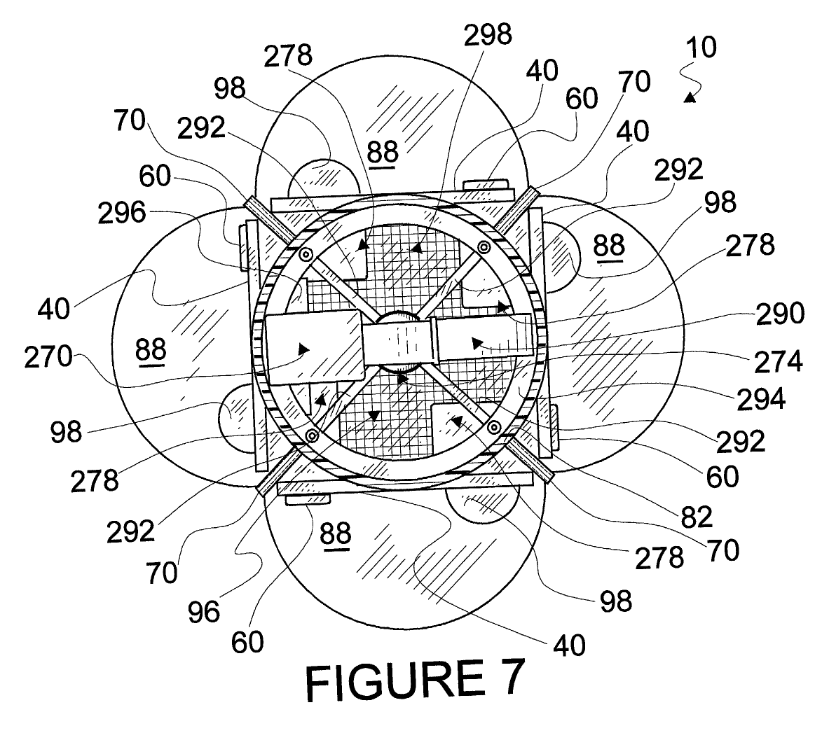

A mechanical layout of station 10 parts is seen in FIG. 7 as a top elevation of station 10 with a section removed. A single printer 270 is disposed within drum 82 (see also FIG. 1). Printer 270 is driven through approximately 270° to permit four stations to be serviced in a time shared fashion. A bi-directional rotary drive motor 274 is centrally disposed to direct output of printer 270 to an appropriate predetermined slot 40 (see FIGS. 1 and 2). Printer drive motor 274 is interfaced to micro controller 250 through drum drive controller 276 (see FIG. 6). Design of such motor drives and drive controllers are well known in digital computer control art. By using a single printer 270, capacity is provided for a large paper roll 290.

Struts, generally numbered 292, radiate outward from drive motor 274 to a mounting ring 294 upon which printer 270 and paper roll 290 are firmly affixed. Angular rotation of mounting ring 294 is restricted to the approximately 2700 to alleviate wiring problems. Disposed inferiorly to printer 270 is a case 296 which holds a station 10 control subsystem which includes microprocessor 250 and associated electronics (see FIG. 6). Further, four bar code readers, each numbered 278 are disposed inferior to case 296, each being in a vertical line with a shelf 98. At the bottom of enclosure 96 is a mesh flooring 298, upon which coupons can fall after being ingested into station 10. Note that use of mesh flooring 298 permits air flow to be communicated from base member 80 (see FIG. 1) upward through station 10. For a clearer representation of dispositions of printer slot 40, magnetic strip reader 60, supporting members (generally numbered 70) and convenience shelves, each numbered 88, see FIGS. 1 and 2.

While there are many printers which may be profitably used in station 10, printer 270 may be a thermal roll printer model 8900 available from Westrex International. Paper width may be up to 4.5 inches and Windows based drivers are available. However, it may be desirable to select a printer having a gate for each list produced, the gate being released to dispense the list only after completion of a printing cycle to reduce likelihood of premature pulling on the list and distorting print, especially bar code print.

Coupon insertion drive 292 may be similar in form and function to an insertion drive for an inserted bill in an automatic money exchange machine. Note that an accepted product coupon is ingested into station 10 while a coupon, which is outdated, has unreadable code or is unredeemable in the establishment where kiosk 10 is being used, should be returned to the coupon provider who is using kiosk 10.

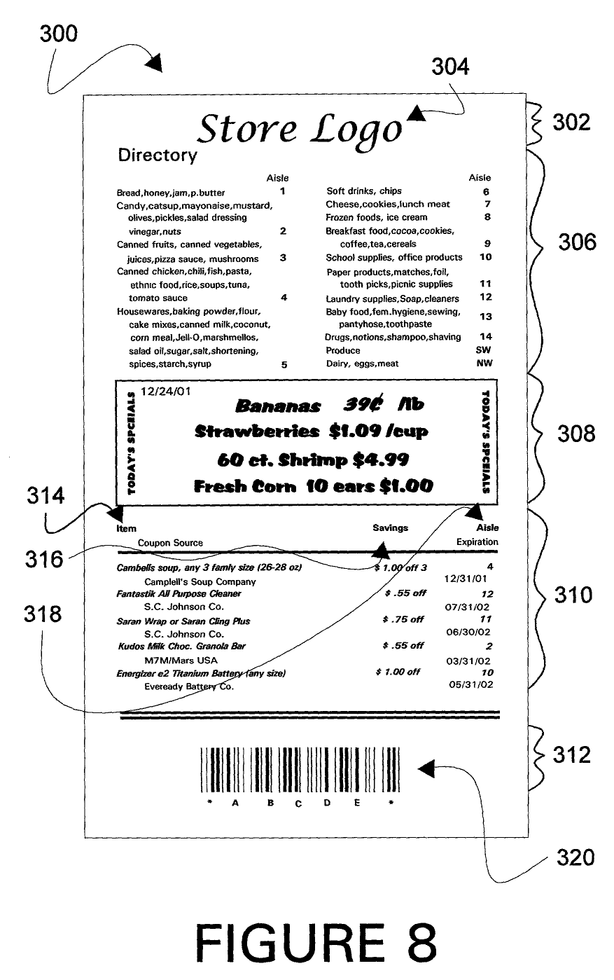

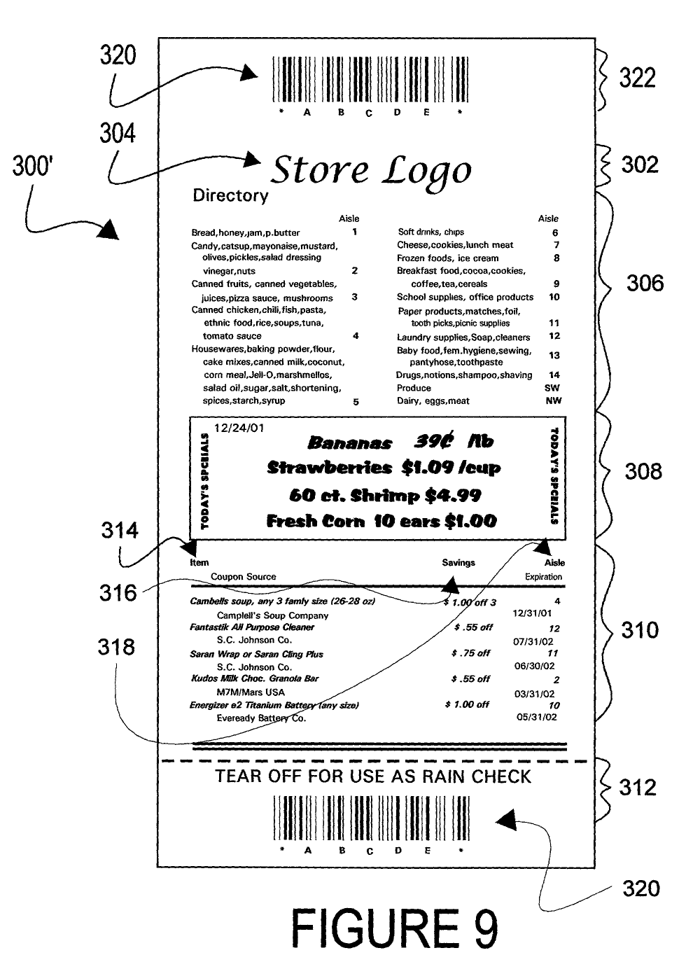

As mentioned heretofore, a primary purpose of station 10 is printing of a coupon shopping list. Examples of such lists are seen in FIGS. 8 and 9. In FIG. 8, a coupon shopping list 300, from top to bottom, is seen to comprise an area set apart by bracket 302 for an establishment logo 304; a store directory, set apart by bracket 306; a specials section set apart by bracket 308; an area list of coupons set apart by bracket 310 and a bar code identifier set apart by bracket 312. It should be noted that only the list indicated by bracket 310 and bar code identifier indicated by bracket 312 are required items. All other indicia on list 300 is provided for convenience and aesthetics.

Though not specifically required by the invention, use of station 10 may be enhanced by the directory section of bracket 306, especially for those customers who may be unfamiliar with store layout. The section of bracket 308 (which may also contain reference to in-store coupons) may provide increased incentive to establishment management for employing use of system 100.

The section set apart by bracket 310 provides a list of all coupons selected at station 10. As seen in FIGS. 8 and 9, such information may be divided into three columns, item and coupon source column 314, savings column 316 and isle and expiration date column 318, although other printed forms of shopping list 300 may be used within the scope of the invention. Noting that the customer who receives shopping list 300 is not obligated to buy any item listed thereon, savings column 316 permits a site of selection decision to intelligently be made in light of other competitive products which are likely to be disposed nearby. Also, conditions required for validation may also be printed in column 316.

Identity of each product and coupon originator (CO or responsible party) may be provided in column 314. Important parameters, such as size, may also be cited in column 314. Note the critical information such as the expiration date for each listed coupon may be found in column 318. While printing of an associated aisle may not be critical, it may often be quite helpful to a consumer who is unfamiliar with store layout.

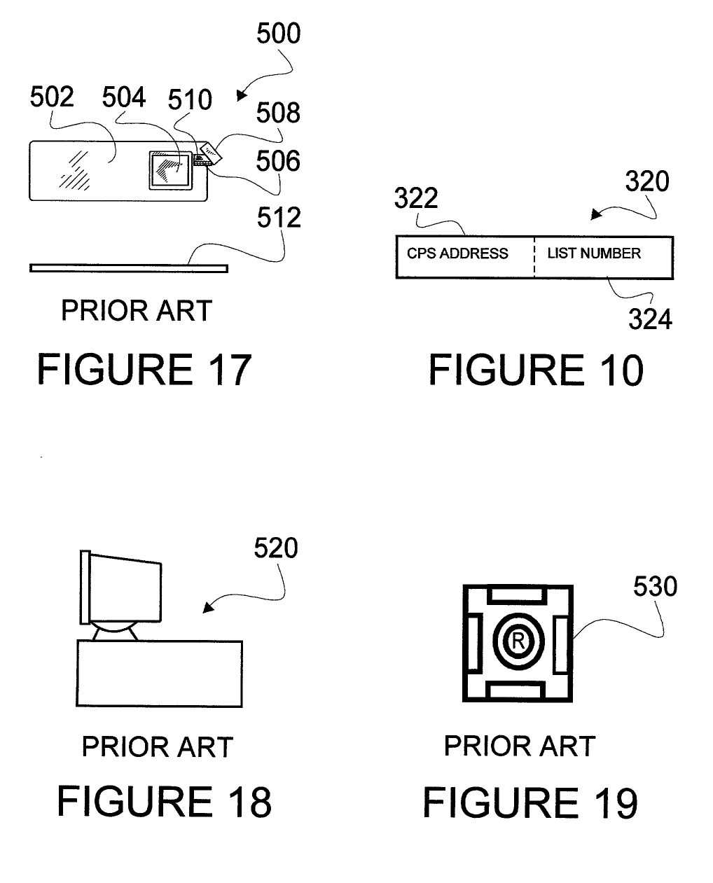

A bar code set apart by bracket 312 provides the single identifier (in this case bar code 320) required to identify and process all coupons on list 300. As seen in FIG. 10, bar code 320 comprises two sections, a subsystem 120 address code 322 and a number 324. This combination uniquely identifies each list 300 from all other lists generated by this subsystem 120 and all other lists generated by each other subsystem 120. While a bar code is directly applicable to contemporary check-stand operation, the scope of the invention is not limited to identifying each shopping list 300 via a printed bar code 320. As examples, magnetic strips, magnetic ink, printed alpha-numeric indicia or even identities stored in smart cards may be use for list 300 identification.

It is considered prudent to permit each coupon shopping list 300 to be use in but one purchase and may be kept by a check-stand clerk. Even so, if desired, coupon shopping lists may be used more than once; in such a case, those coupons which are no longer valid after a purchase has been made are canceled from an associated file in list insertion hub memory at the time of use.

To provide a “rain check” opportunity, a second form of a shopping list, numbered 300′, may be printed as seen in FIG. 9. Shopping list 300′ is like shopping list 300, except for a second bar code 320 being added at the top of list 300′. Having a second bar code 320 section 322, permits one bar code section, such as section 312 to be torn and inserted into bar code slot 30 in station 10. In this manner, a new shopping list 300 which provides a rain check for unavailable merchandise and/or for later purchasing of currently undesired items to be made later may be newly printed by inserting bar code 320 into station 10.

Also, should a previously produced coupon shopping list 300 be printed in a first store and desired to be used in another store, inserting the previously produced coupon in a station 10 of the other store permits all unused and unexpired coupons to be extracted from files in the first store and printed in the form of a new shopping list in the other store. Hereafter, all coupon shopping lists shall be referenced by 300, whether it has a form of coupon list 300′ or another form for clarity of presentation.

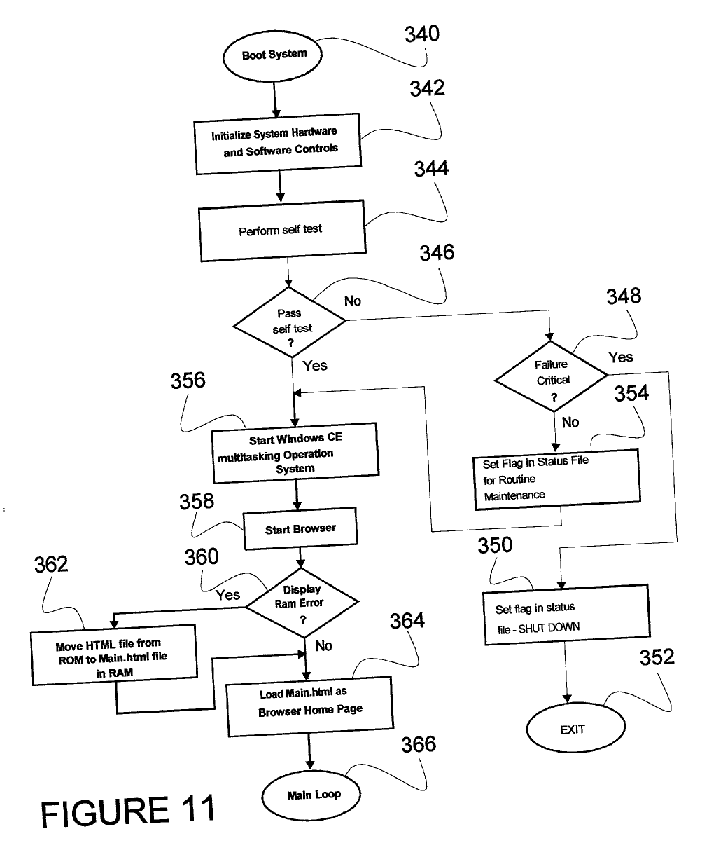

Reference is now made to FIGS. 11-16 wherein program flow for coupon processing station 10 is seen. In flow diagrams in the drawings, an oval indicates either starting or continuing program flow. In the case of continuing flow from a first to a second oval (in another drawing), a reference number and a prime of the reference number, respectively, is used to associate the first and second oval (double primes and alphabetical suffixes are used where required by multiple continuations; a rectangle indicates performance of a programmed function and a diamond indicates execution of a decision. One who is skilled in digital computer programming art understands that details of programming, such as housekeeping routines, general systems subroutines, and other programs which are commonly used in contemporary computer processing need not shown and restricting such disclosure provides clarity to those programming elements which are more closely related to making and using the instant invention.

As seen in FIG. 11, operation of coupon processing station 10 is initiated by a standard booting process as identified by entry oval 340. As indicated by function block 342, hardware and software controls are initialized. Preferably, following initialization, a self test is performed via function 344. Such self-testing is well known and standard for contemporary computer systems.

If the self test is not successful (decision 346), a determination is made as to whether or not any discovered failure is critical (decision 348). If any failure jeopardizes further station 10 function and recovery cannot be achieved internally, a status flag is set and station 10 is shut down by function 350. When possible, a message is immediately sent to insertion hub 160 for immediate transmittal to controller subsystem 110 to initiate a maintenance call. Exit 352 is a null state which is recovered by restarting through oval 340.

If all detected failures are non-critical in nature (e.g. a dropped memory bit which occurs randomly and can be reset), decision 348 directs program activity to function 354. Function 354 causes a flag to be set in a status file as an indicator for performance of routine maintenance. Program flow continues to function 356, a function arrived at directly if self test function 344 is successfully passed.

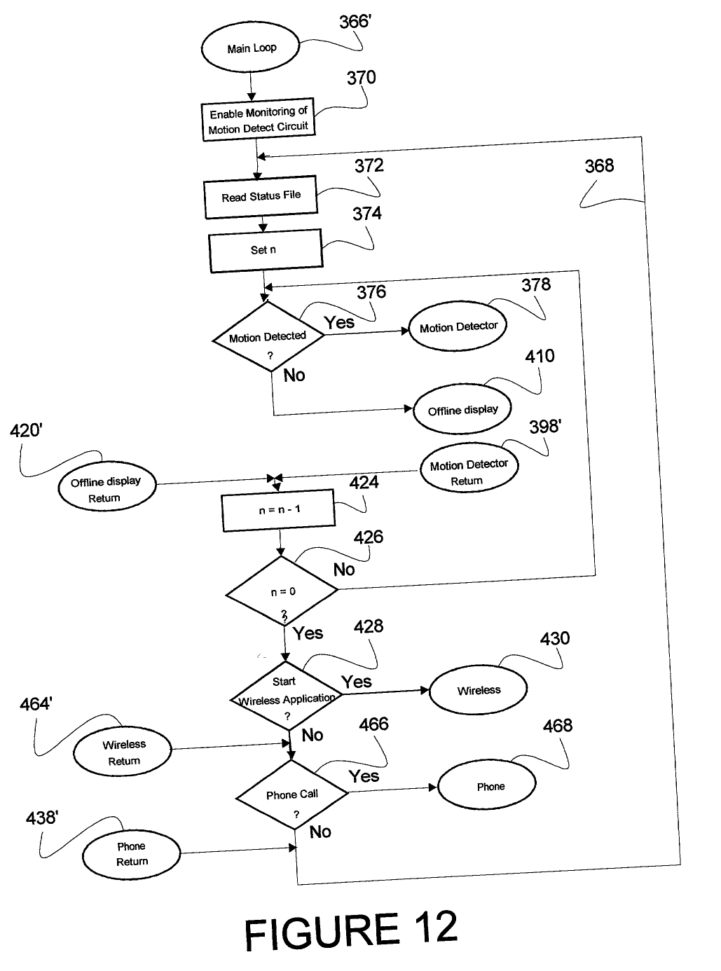

Following the self test sequence, Windows CE Operating System is entered at function 356. The aforementioned browser is begun by function 358. If a display RAM error is detected (decision 360), an HTML file, stored in ROM, is transferred to “main.html” in RAM (function 362). In any event, “main.html” is loaded as browser home page (function 364). Once function 364 is completed, a main program loop of coupon processing station 10 is entered via oval 366 to oval 366′ (see FIG. 12).

Stored in the status file of each coupon processing station 10 are flags which indicate activity requirements in the areas of 20 motion detection, off-line display scheduling and wireless/phone operation. Before entering a major loop portion (indicated by line 368, function 370 enables motion detector circuit 50. To establish bases for operation within the main loop 368, the status file is read for processing in function 372.

Following function 372, a station 10 booth flag (n) is set by function 374 to permit individual attention to be paid to each booth. Note that each booth 12, 12′, etc. shall be hereafter generally referenced by subscript notation, i.e. 12(n), where n is a subscript which delineates each separate booth of station 10. As an example, if station 10 has four booths, “n” is set to four.

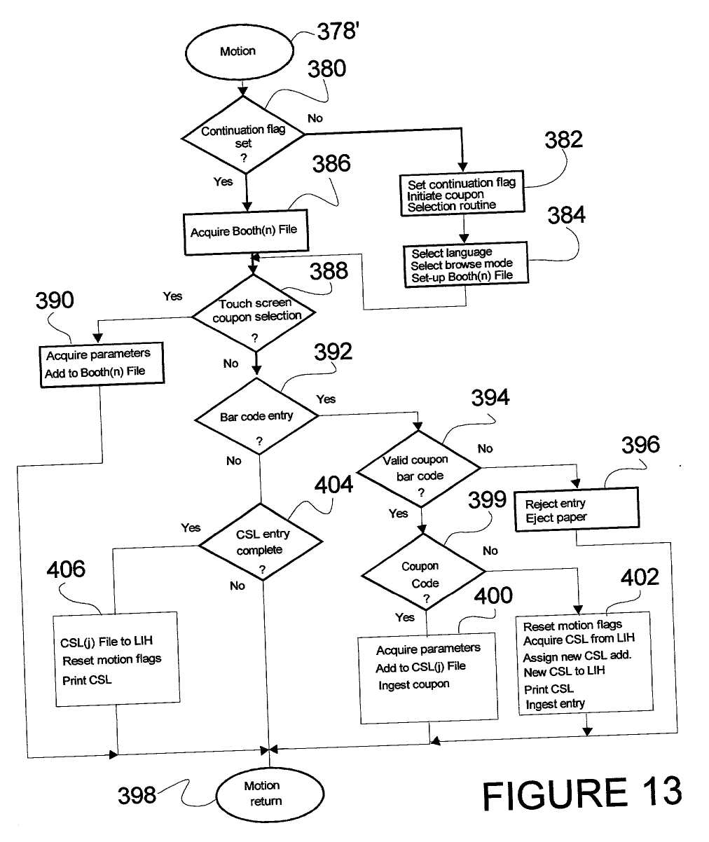

Decision 376 determines whether a prior motion has been detected (by a status flag) or if motion is newly detected at booth 12(n). If motion at booth 12(n) is detected, program flow passes through oval 378 to oval 378′ (see FIG. 13).

Decision 380 accesses the status file to determine whether or not a continuation from prior motion entry flag is set. If not, this is first entry after any reset caused by motion detection at booth 12(n). As such, function 382 is entered whereat the continuation flag is set and a coupon selection routine is begun on display 20 of booth 12(n). Function 384 follows function 382 to begin booth 12(n) shopping list 300 generation activities. Among activities associated with beginning the coupon selection routine are language selection for printed material (and audio, if used), selection of a coupon browsing mode and initialization of a new coupon shopping list (CSL) 300 file to be stored ad interim in a booth 12(n) temporary file. Each shopping list 300 ultimately is assigned a separate file to be hereafter referenced as CSL(j) file. Note that “j” is a subscript which identifies the shopping list first in station 10 and later in list insertion hub 160. Subscript “j” also directly correlates with list number 324 of bar code 320. A record of the current status file and critical parameters required for coupon shopping list 300(j) generation are stored in a temporary file associated with booth 12(n).

If decision 380 determines that the continuation flag is set, function 386 acquires booth 12(n) temporary file. Note that the booth 12(n) temporary file now contains a shopping list 300(j) file in progress as received from either function 384 or function 386.

If decision 388 determines that a coupon has been selected via touch screen panel 24, a related coupon parameter storage file (CPSF) is accessed as a part of function 390. For brevity such a file is referenced as CPSF(k), indicating the kth coupon address. From CPSF(k), such pertinent coupon parameters as expiration date, printed language description of a product or set of products which must be purchased to validate redemption of the kth coupon, conditions for validation, amount of savings related to redemption and CO name. Also, in-establishment location of the product or set of products may be acquired as part of each CPSF(k). This information is added to the booth 12(n) temporary file.

If decision 388 shows no panel 24 input, program flow continues to decision 392 whereat a bar code entry determination is made. If a product bar code has been read in booth 12(n) bar code reader 278, the bar code is first checked (decision 394) for validity (e.g. for parity). If the acquired bar code is not valid, resulting function 396 rejects any so inserted bar code candidate and ejects any inserted item (e.g. paper) from slot 30. From function 396, flow proceeds to motion return oval 398.

If the bar code is valid, decision 399 tests the read bar code for being code for a coupon shopping list 300 or a product bar code. The test for a coupon shopping list 300 bar code is by determining whether or not the code is found within any CPSF as being a bar code field 320(j), where, in this case, “j” is any previously issued coupon by station 10 or being a bar code field 320 having a CPS address which is valid but not that of this processing station 10.

If the bar code is valid, decision 399 checks for a product bar code. If a product bar code is found, program flow is steered to function 400 which causes the inserted item to be ingested to be stored within enclosure 96 of station 10 (see FIG. 1). As is the case with function 390, function 400 accesses a related coupon parameter storage file (CPSF(k)). From CPSF(k), the pertinent coupon parameters including expiration date, printed language description of a product or set of products which must be purchased to validate redemption of the kth coupon, conditions for validation, amount of savings related to redemption and CO name are acquired. Also, in-establishment location of the product or set of products may be acquired as part of each CPSF(k). Also, as with function 390, this information is added to the booth 12(n) temporary file and, then, program flow continues to return oval 398. Note, that should no CPSF(k) file exist, a request may be sent to LIH 160 to initiate a subsequent request to controller subsystem 110 to acquire the desired purchase coupon parameters. Should no such coupon parameters be found in controller 110, the inserted coupon is rejected (as via function 396).

If the valid bar code is a coupon shopping list 300 code (as determined by decision 399), function 402 generates a revised shopping list 300 from an earlier issued coupon shopping list 300(j). To differentiate between the two shopping lists, the older list is referenced as CSL(old) and the new shopping list as CSL(new). All current file information in CSL(old) is acquired from LIH 160 by communication links disclosed hereafter.

It should be noted that prior use of CSL(old) may have spent some coupon items by redemption and/or some coupons may have expired and/or, for other reasons, it may not be possible to transfer all items from CSL(old) to CSL(new). In any event, if any redeemable items contained on CSL(old) remain, a CSL(new) is printed with a new CPS list number 324. Matter inserted into slot 30 from which the bar code is read is ingested into enclosure 96. Motion flags are reset and a new CSL(j) file, where “j” is the new shopping list identifier, is transmitted to list insertion hub 160. Program flow continues to return oval 398 and therefrom to oval 398′.

If action at booth 12(n) is an entry complete indication following a “no” determination by decision 392, decision 404, steers program flow to function 406. At this point all shopping list 300 data has been entered. Printer 270 prints a new shopping list 300. A “j” address is assigned and CSL portions of the booth 12(n) temporary file is renamed as CSL(j) and transmitted to list insertion hub 160. The temporary file of booth 12(n) is initialized and program flow continues to oval 398 and to oval 398′ (see FIG. 12).

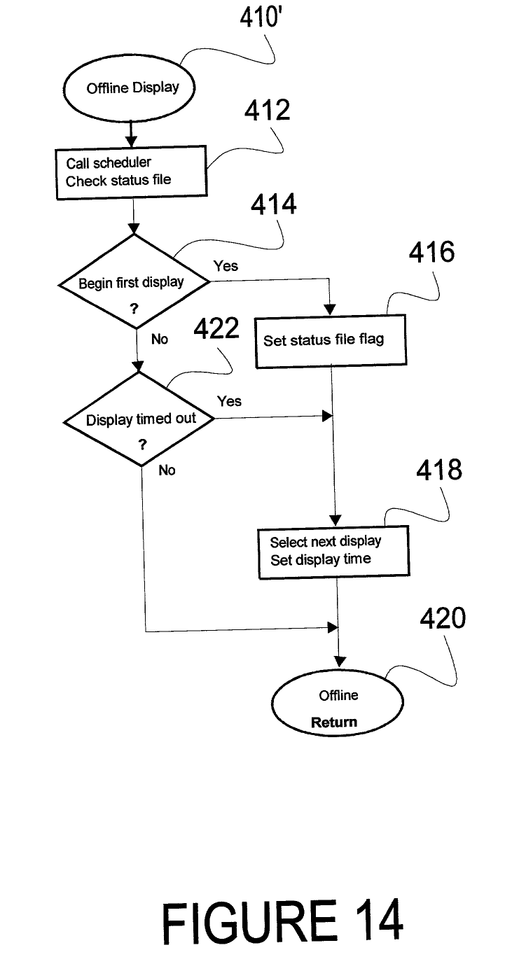

While oval 398′ steers program flow to function 424, a no motion detected determination by decision 376 directs program flow to oval 410 and therefrom to oval 4101, seen in FIG. 14. Accessed through oval 410′, function 412 calls booth 12(n) status file and an off-line scheduler. When a booth 12(n) of station 10 is not being used for coupon list 300 generation, it may be separately used for other purposes, such as showing advertising media. For this purpose, microprocessor 250 has an off-line scheduling program for inserting earlier planned attractions. As off-line media may already be being displayed, decision 414 determines whether or not this is a first entry into an off-line mode. If so, a status flag is set by function 416 to preclude reinitializing the scheduler. Function 418 selects next display from via the scheduler and sets a display time in the booth 12(n) status file. Program flow from function 418 then proceeds through oval 420 to 420′ (see FIG. 12).

If offline displays at booth 12(n) have begun, program flows from decision 414 to decision 422 to determine whether or not a previously begun display has timed out. If so, program flow proceeds to function 418 for selection and initiation of a next media display. In both of these cases, program flow continues to oval 420 and then to oval 420′ (see FIG. 12).

Function 424 reduces “n” by one to effectively change booth 12(n) selection. Next decision 426 redirects program flow to decision 376 if “n” is not equal to zero. When “n” equals zero, flow continues to decision 428.

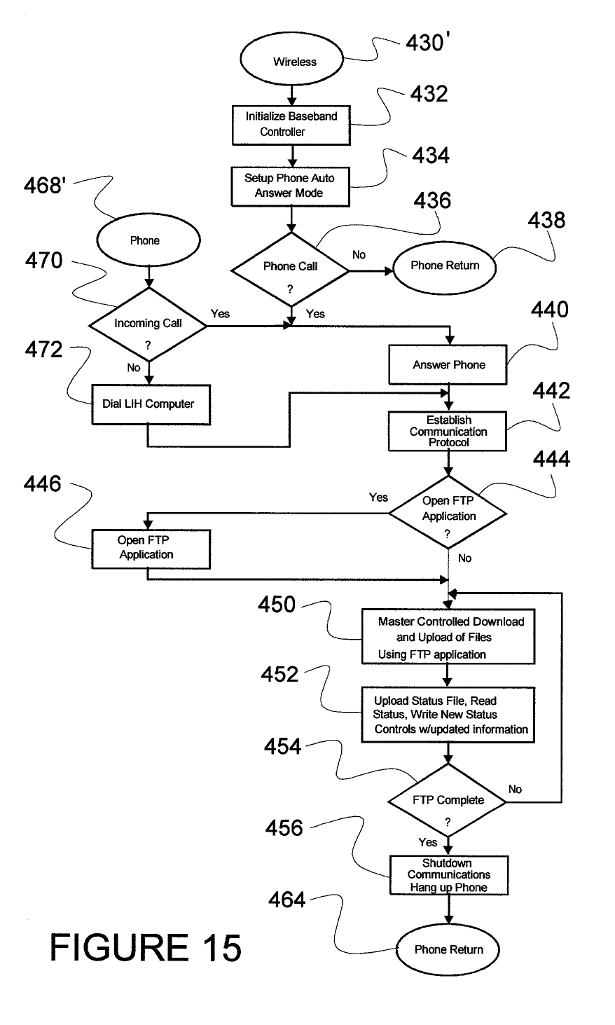

If a start wireless application flag is set, decision 428 directs program flow through oval 430 to oval 4301 (see Figure 15). For wireless operation, the first step (function 432) involves initializing local baseband controller 258 (see FIG. 6), a process which is well known in computer communications art. Function 434 sets phone communication to auto-answer mode. Decision 436 determines whether or not a phone call is on line. If not, oval 438 returns program flow to phone return oval 438′ (see FIG. 12). If so, function 440 answers the call. Communication protocol is satisfied by function 442. If there is need for a file transfer protocol, decision 444 momentarily diverts to function 446 which opens a FTP application routine.

In next function 450, as directed by list insertion hub 160, any specified files are downloaded or uploaded using FTP. The status file is transmitted, via function 452, to list insertion hub 160 with any new status information. If FTP operation needs repeating (decision 454), program flow returns to function 450. Otherwise, program flow proceeds to function 456 which shuts down communications and hangs-up the phone. Exit from wireless application is through oval 464 to 464′ (see FIG. 12).

Note, in FIG. 12 that oval 464′ and a “no” result of decision 428 steers program flow to decision 466 which, when affirmatively determined by a phone request flag in the status file, directs flow outward through oval 468 to 468′ of FIG. 15. If the phone request flag (determined by decision 470) is set for an incoming call, program flow continues to function 440 which is earlier disclosed, herein. Otherwise, function 472 dials list insertion hub 160 and, upon connection, program flow continues to function 442, also as earlier referenced.

It may be noted that main loop 368 of station 10 involves coupon selection alternated with media display and transmittal for files to and from list insertion hub 160. From a media display mode, a coupon selection mode is generally begun by detecting motion, although a simple touch of a panel 24 screen should also initiate a coupon communications mode, just as a touch of a mouse pad or a key on a keypad brings a computer out of a screen saver mode.

List Insertion Hub and Coupon Validation

Reference is now made to FIG. 5 wherein a list insertion hub 160 is seen schematically. In addition to antennae 164 and 166, list insertion hub comprises a central control computer electronics package 480 and a connecting hub 490. As is disclosed in detail, hereafter, connecting hub 490 may be provided in many forms, depending upon characteristic design and implementation of each transaction processing computer system used in the establishment in which each computer processing subsystem 120 is installed.

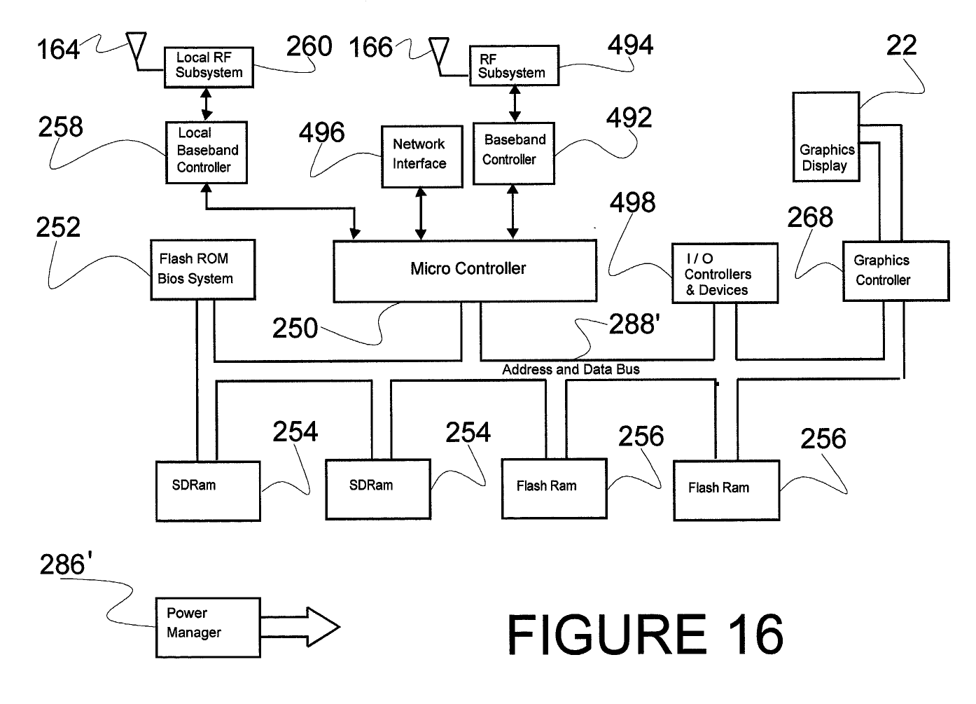

List insertion hub 160 is microcomputer based, similar to coupon processing station 10. Hub 160 comprises a number of functional subassemblies as seen in FIG. 16. Basic subassemblies of hub 160 are a micro controller 250; memory modules including a flash ROM bios system 252, SDRam modules 254 and flash RAM modules 256; a local baseband controller 258 and associated RF subsystem 260 with antenna 164; a graphics display 22; associated graphics controller 268; a baseband controller 492 and associated RF subsystem 494, which in association with antenna 166 has long range communications capability; a communicating hub 496 and a power manager module 286′.

Note that an address and data bus 288′ is used to communicate from micro controller 250 to flash ROM 252, SDRAM 254, Flash RAM 256, touch screen controller 272, graphics controller 268. Like power manager 286 of coupon processing station 10, a power source for power manager 2861 should be made available from establishment electrical power. Other augmenting subassemblies which may be profitably utilized are a printer and a scanner, however these are not shown, although an auxiliary I/O interface module 498 is seen in FIG. 16. Such augmenting subassemblies are considered accessorial in nature.

Microprocessor 250 must be capable of time sharing a plurality of processes including, but not limited to:

1. receiving and storing each coupon processing station 10 generated coupon shopping list 300(j) for future reference as communicated through antenna 164, local RF subsystem 260, and local baseband controller 258 (see FIG. 16);

2. receiving and creating a purchase list file(e), “e” being a subscript referring to a particular check-stand, for each sales transaction performed at each check-stand(e) in the establishment where coupon processing subsystem 120 is installed;

3. verifying purchases associated with each coupon listed on list 300(j) to validate proper use of each such coupon;

4. communicating a bar code representative of each so validated coupon to a central store computer which normally receives sales transactions from each check-stand;

5. sorting validated coupons by company and product and coupon type into files for transmission to controller subsystem 110;

6. communicating bidirectionally over antenna 166, RF subsystem 494 and baseband controller 492 (see FIG. 16) to:

a. receive amendments, deletions and additions to coupon data files from controller subsystem 110;

b. receive advertising files and schedules for subsequent transmittal to station 10;

c. transmit sorted files to controller subsystem 110 for billing purposes;

d. transmit other operational information such as ratios of product items purchased with coupons vs all such items purchased with and without coupons;

7. using a controller subsystem 110 assigned “k” subscript address, as earlier described, for newly added coupons, establishing a new coupon parameter storage file (CPSF(k));

8. communicating all received amendments, deletions and additions to station 10 to appropriately modify each associated CPSF(k) therein and to reschedule and rearrange advertising media as appropriate;

To meet such requirements, an Intel StrongARM SA-1110 which is a high-performance, low-power processor for portable wireless multi-media devices may be used for micro controller 250 for hub 160. As earlier disclosed, StrongARM SA-1110 is a 32-bit processor that incorporates Intel design and process technology. Memory control of the SA-1110 supports SDRAM, ROM, flash RAM and other types of memory. As an example, SDRAM modules 254, flash ROM 252 and flash RAM modules 256 are interfaced with micro controller 250 through data bus 288′.

In this case, also, Windows CE is currently the operating system of choice, including applications for Windows media player version 7.1 or higher, pocket Internet explorer browser and FTP data transfer. Flash ROM 252 is programmed with Bios to start the CE operating system and to run selected startup application programs.

Graphics controller 268 of hub 160 may also be an MQ-1132 unit from MediaQ. The MQ-1132 is an integrated LCD and peripheral controller with embedded memory for portable devices requiring high performance. As such, graphics controller 268 readily interfaces with the Intel SA-1110 microprocessor of micro controller 250. In addition, software facilely accesses with the MQ-1132 of graphics controller 268. Further the MQ-1132 is easily interfaced to many different sizes and formats of LCD screens. LCD screen and touch panel 20 may be 15 inch MTK1500 panel mount from Touch Screens Inc., www.touchwindow.com. Of course, other display modules and touch panels with different sized displays may be used within the scope of the present invention to provide a variety of sizes and pixel resolutions. There is no specific requirement for a touch panel in list insertion hub 160, although such may eliminate necessity for a mouse.

Symbols used in disclosing hub 160 electrically communicating devices within a merchandising establishment are seen in FIGS. 17, 18 and 19. In FIG. 17, a check-stand, generally numbered 500, is seen to comprise a work surface 502, a bar code reader (and scale) 504 associated with work surface 502, a key pad entry 506, a display module 508 and a printer 510. Further a divider wall 512 is generally placed to separate a cashier from customers at an adjacent check-stand 500, when a plurality of check-stands are serially aligned.

An in-establishment store computer, generally numbered 520, is seen in FIG. 18. In store computer 520 generally receives bar code and other information generated at check-stand 500, processes the bar codes and other information and returns totals and codes for indicia and other information to be printed as a sales slip on printer 510. It is well known in retail merchandising that the sales slip represents a sales contract between the issuing establishment and customer making the purchase. Computer 520 may be made in many forms, a plurality of which are currently widely used in retail establishments.

Referring to FIG. 3, a plurality of store devices, each generally numbered 521 and enclosed by a dashed line 522 includes a store computer 520 and a group of check stands, each numbered 500, are seen. Each LIH 160 of each coupon processing subsystem 120 communicates with a set of devices 521 via an electrical connecting line, generally numbered 524. Note that each line 524 may be configured in a specific fashion depending upon electrical construction of devices 521. Examples of such configurations and resulting connections between a set of devices 521 and a subsystem 120 are disclosed in detail hereafter.

A repeater hub 530 is seen in FIG. 19. Such repeaters are commonly used in ethernet applications. In a repeater hub, the ports combine network segments together to create a single LAN channel.

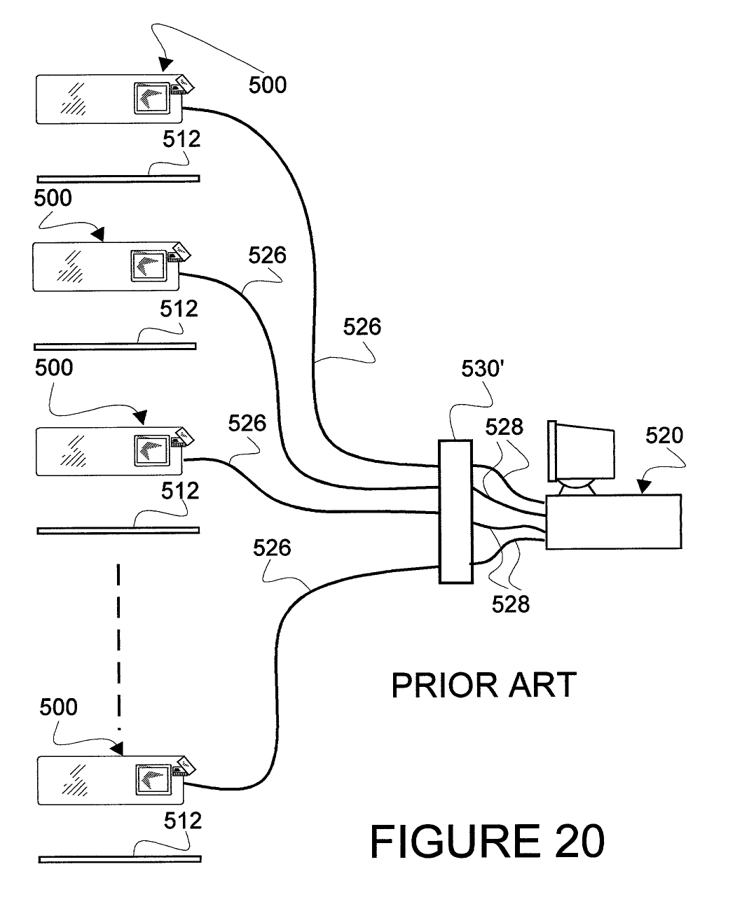

Communications between check-stands 500 and a store computer 520 may be accomplished in a variety of ways, depending upon selection of communicating equipment made by a vendor of devices 521. An example of one mode of interconnection is seen in FIG. 20. In FIG. 20, each check stand 500 communicates with store computer 520 serially via wires, generally numbered 526 through a plug-in module 5301 and therefrom via wires generally number 528 to computer 520. In this mode, each check-stand 500 has a directly addressable wire connection to computer 520. This example of a serial communication is well known in the computer art, though not currently commonly used.

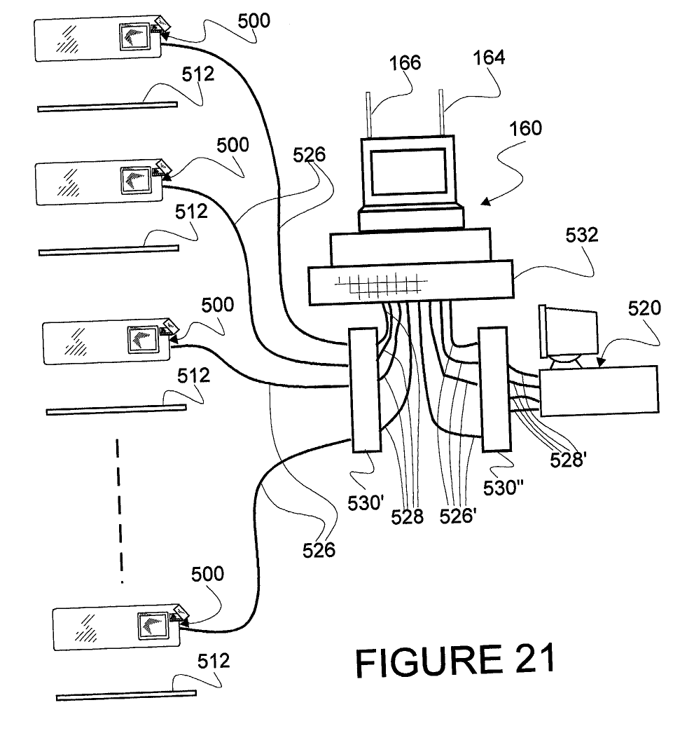

Reference is now made to FIG. 21 wherein each check-stand 500 is similarly connected to a plug-in module 530′ via wires generally numbered 526. However, different from FIG. 20, wires 528 are directly connected to a second plug-in module 532. Plug-in module 532 communicates with other portions of list insertion hub 160 while acting as a serial network interface 496 (see FIG. 16). In this manner, each bar code and other keyboard command information sent from each check-stand 500 toward computer 520 is intercepted via plug-in module 532. Each item purchased is stored in a file, generally referenced as the “eth” check-stand transaction file (CSTF(e)), where “e” is a number associated with a particular check-stand 500.

List insertion hub 160 regularly passes all such bar code and other keyboard command information, with two exceptions, directly onward to computer 520 through wires 526′, plug-in module 530″ and wires 528′. The exceptions are sensing of a computer shopping list 300(j) bar code and of a “total” command or any other command which signals end of a buying transaction. When a list 300(j) bar code is recognized, coupon file, CSL(j), is accessed from memory and each coupon bar code product parameter is compared against purchased items in CSTF(e). Whenever a criteria of any coupon as stored in CPSF(k) is met by purchased items, bar code of a so validated coupon identified by CPSF(k) is communicated to store computer 520.

Upon detection of a total command, or other command signaling end of a transaction, that command is trapped and retained in hub 160 until all items in CSL(j) have been processed and associated bar codes have been transmitted to store computer 520. (Note, trapping of the total command is only required when list insertion hub 160 is installed without a change to store computer 520 software.) Upon completion of processing (validating all properly redeemed coupons) of all such CSL(j) items with subsequent transmittal of bar codes to store computer 520, the trapped and retained command is communicated to store computer 520.

The standard process follows whereby store computer 520 communicates to check-stand 500(e) a list of validated coupons, reduces the transaction total by a value equal to the sum of the worth of the validated coupons and communicates the final transaction total to checks stand 500(e). As a result, the ultimate printing of a sales receipt culminates the sale. Note, that a so connected and operated hub 160 places no new requirements on store computer 520 and therefore requires no change in software in store computer 520 to implement system 100.

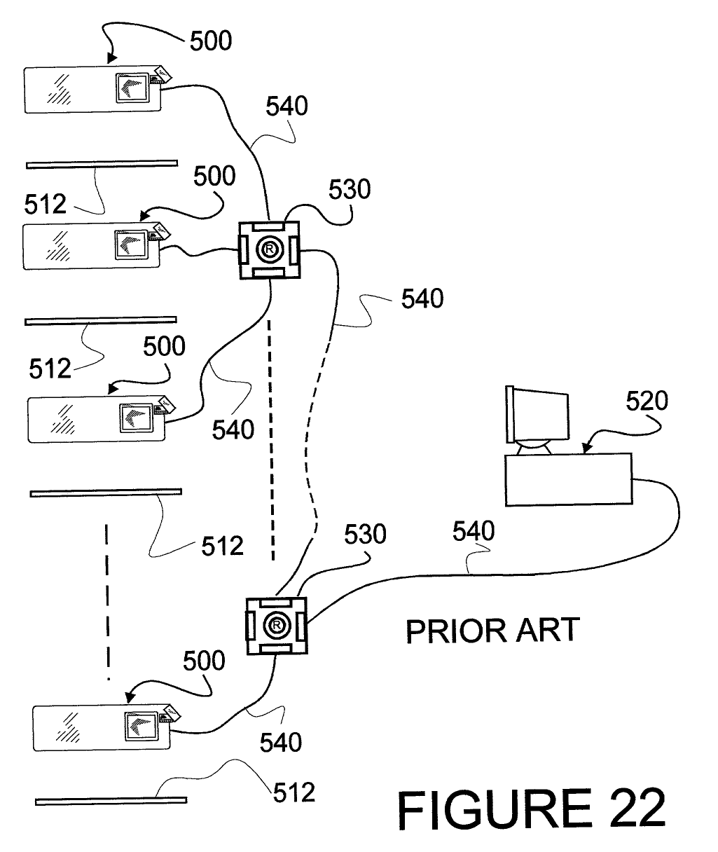

Reference is now made to FIG. 22 wherein a mode of communication between a plurality of check-stands, each numbered 500, and a store computer 520 is seen to be via an ethernet.

Though not necessarily so, generally, at least one repeater 530 may be used to augment network data flow. As inter-segment wiring is standard in an ethernet, all wires bear like numbers of 540. Operation of ethernet communications is well known in computer networking art and will, therefore, not be dealt with further herein.

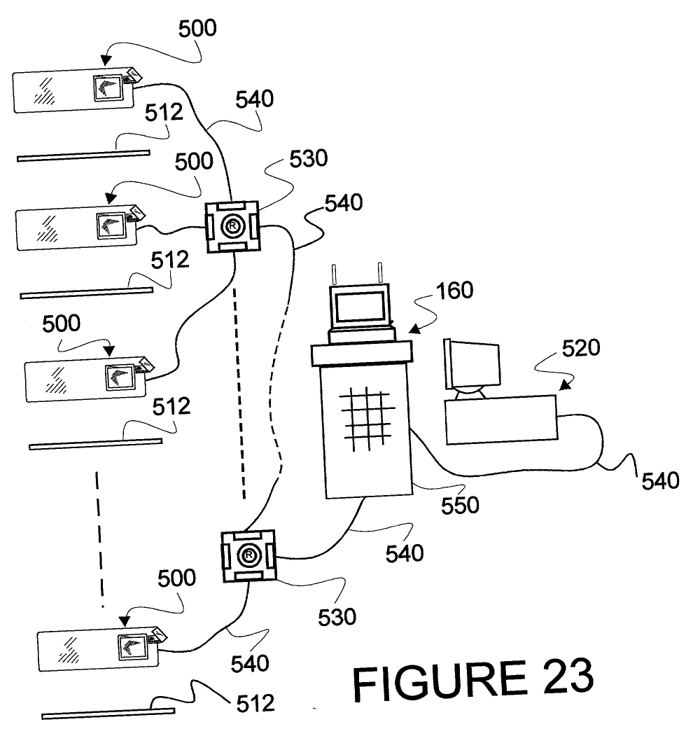

An ethernet switching hub 550 as an interface for network interface 496 (see FIG. 16) of list insertion hub 160 is seen interposed into an ethernet network (which is similar to the network seen in FIG. 22) between a repeater 530 and a computer 520 in FIG. 23. In this mode of communication and as earlier disclosed, list insertion hub 160 regularly passes all product bar codes and other keyboard command information, with two exceptions, directly onward to computer 520 through wires 540. The exceptions are a computer shopping list 300 bar code and a “total” command or any other command which signals end of a buying transaction. When a list 300(j) bar code is recognized, coupon file, CSL(j), is accessed from memory and each coupon bar code product parameter is compared against purchased items in CSTF(e). Whenever a criteria of any coupon as stored in CPSF(k) is met by purchased items, bar code of a so validated coupon identified by CPSF(k) is communicated to store computer 520.

Recognition of a total command, or other command signaling end of a transaction in switching hub 550, causes that command to be trapped and retained in hub 160 until all validated coupon items in CSL(j) have been processed. Upon completion of all such CSL(j) items, the total or other like command is communicated to store computer 520, subsequently leading to communication of information related to validated coupons and a transaction total to check-stand(e) and ultimate printing of a sales receipt along with standard culmination of the check-stand(e) sale. Note, that a so connected and operated hub 160 places no new requirements on store computer 520 and therefore requires no change in software in store computer 520 to implement system 100.

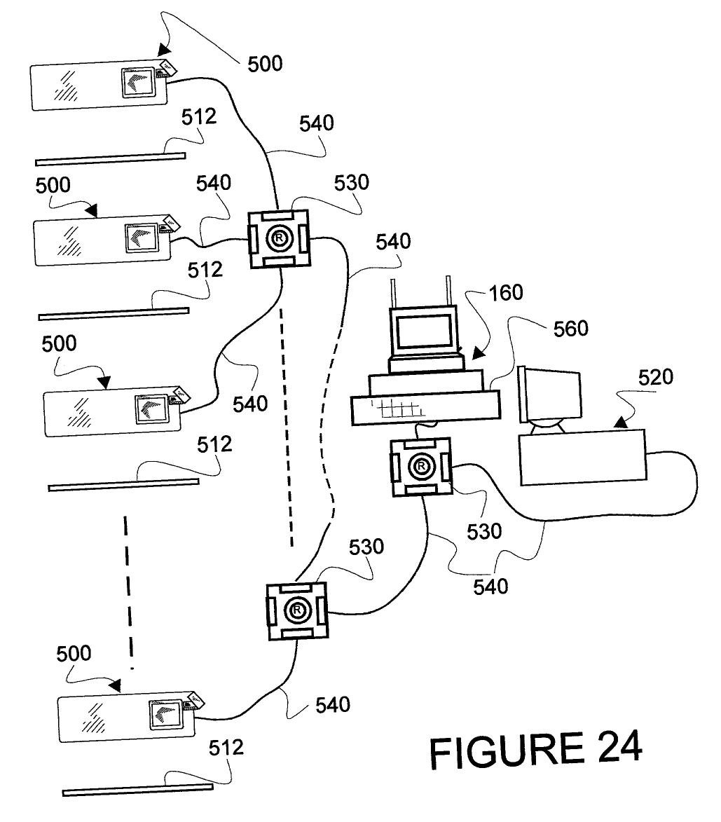

In those cases where it is permissible to make moderate changes in store computer 520 operating software, simple software modifications permit an ethernet configuration as seen in FIG. 24 to be used. Note that an additional repeater 530 is interposed between repeater 530 and store computer 520. An ethernet interface 560 is disposed as a part of network interface 496 (see FIG. 16). In such a communications mode, hub 160 cannot trap any commands or data transmitted between a check-stand 500 and store computer 520. For this reason, store computer 520 must recognize a computer shopping list 300(j) bar code and await transmission of bar codes of associated validated coupons from computer shopping list 300(j) items before acting on a total or other transaction ending command from the associated check-stand 500.

Even so, when a list 300(j) bar code is recognized, coupon file, CSL(j), is accessed from hub 160 memory and each coupon bar code product parameter is compared against purchased items in CSTF(e). Whenever a criteria of any coupon as stored in CPSF(k) is met by purchased items, bar code of a so validated coupon identified by CPSF(k) is communicated to store computer 520 along with any other information required for processing the bar code, such as value of the coupon and indicia to be printed on the sales receipt if such is not already stored in computer 520.

One skilled in computer programming would recognize that all functions performed in list insertion hub 160 can be performed in a store computer 520, with appropriate software. However, in such a case, coupon validation would then be performed by a device under control of the establishment. Such may not be acceptable to coupon originators as there is no third party verification of actual sales against coupon redemption.

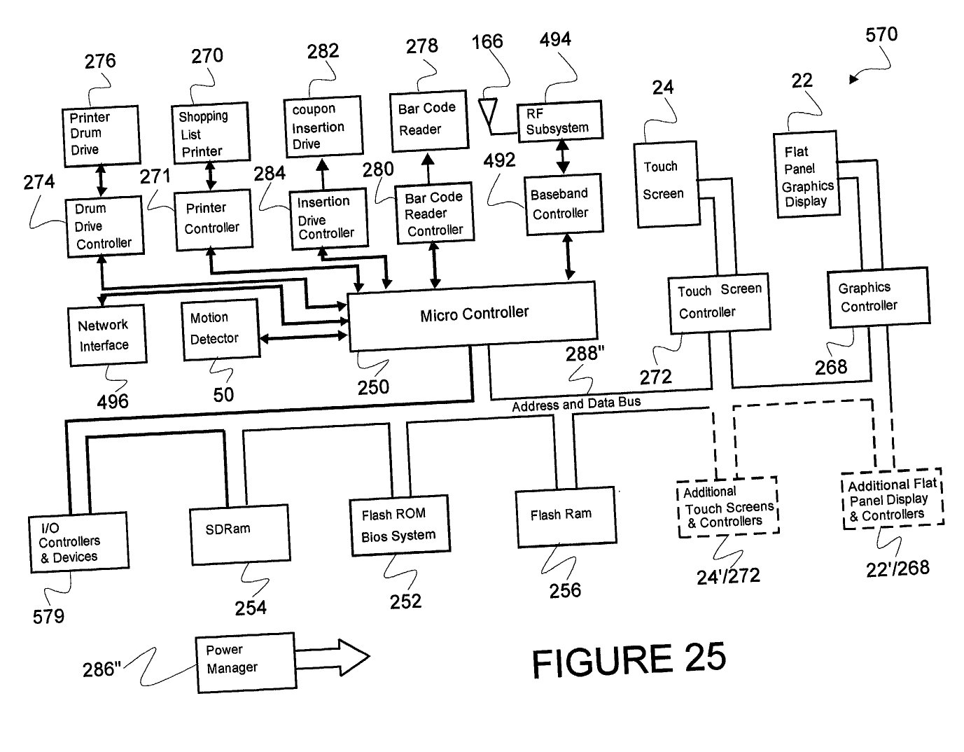

In some store environments, coupon processing station 10 and list insertion hub 160 may be combined into a single unit. As seen in FIG. 25, a combined processing station and hub subsystem 570 comprises many of the same parts as are used in a separated station 10 and hub 160 subsystem 120. However, in combined subsystem 570, there is no need for local communications and manual communications with subsystem 570 may be made through existing touch screens 24 and graphics displays 22 already employed in a kiosk 10.

Subsystem 570 comprises a number of functional subassemblies as seen in FIG. 25. Basic subassemblies of subsystem 570 are a micro controller 250; memory modules including a flash ROM bios system 252, SDRam module 254 and flash RAM module 256; a motion detector 50; at least one LCD screen 22 and touch panel 24 with associated controllers 268 and 272, respectively; a printer 270 and associated printer controller 271 for producing a coupon shopping list 300; a printer drum drive 274 and drum drive controller 276; a bar code reader 278 and bar code reader controller 280; a coupon insertion drive 282 and insertion drive controller 284 and a power manager module 286″.

A power source for power manager 286″ should be made available from establishment power. Other augmenting subassemblies which may be profitably utilized are a magnetic strip reader 60 (seen FIGS. 1 and 6, but not shown in FIG. 25) and video camera and a speaker, not seen in the Figures. These augmenting subassemblies are considered potentially valuable but accessorial in nature. Also, other controllers and devices may be added as deemed appropriate. For this purpose, an interface 579 may be added.

The above designated parts are common to station 10. Other parts which are required for subsystem 570 to also function as a list insertion hub are baseband controller 492, RF subsystem 494 and antenna 166 by which subsystem 570 communicates with a controller 110. Also a network interface 496 is required by subsystem 570. Other parts which are optional are additional touch panels and controllers, generally numbered 24′/272′, and additional flat panel displays and associated controllers, generally numbered 22′/268′. An address and data bus 288″ performs functions similar to address and data buses 288 and 288′ of station 10 and list insertion hub 160, respectively.

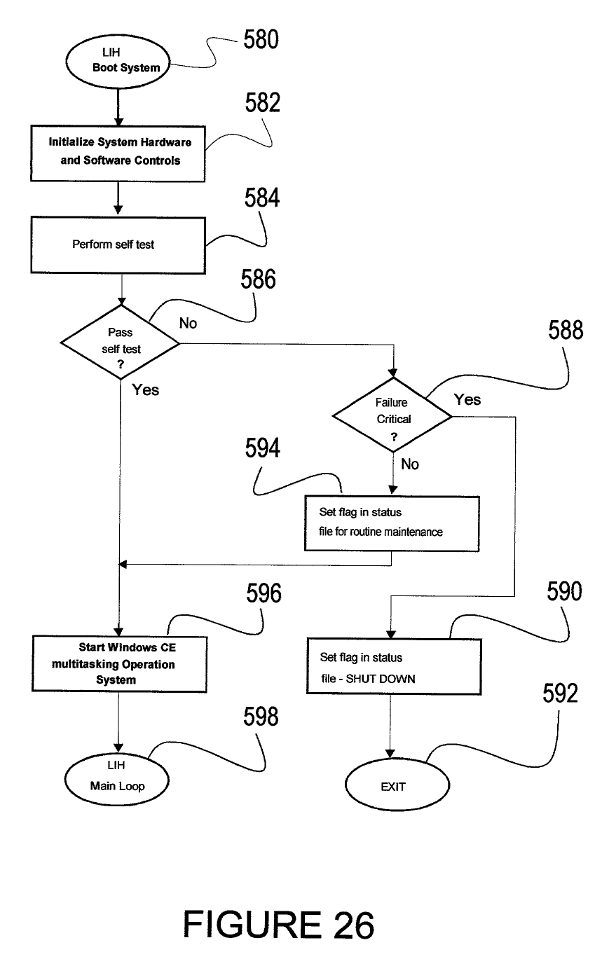

Reference is now made to FIGS. 26-42 which provide flow charts for programming list insertion hub 160. As seen in FIG. 26, programming of micro controller 250 begins via oval 580 to function 582 which initializes list insertion hub 160 (also referenced as LIH 160, herein) hardware and software controls. Such initialization is common practice in micro controller programming and will not be dealt with further herein. Also, as is a norm in contemporary programming, subsequent function 584 performs a self-test of LIH 160. If at decision 586, the self test fails, an evaluation of any failures at decision 588 determines whether or not operation of LIH 160 may continue.

If any failure is determined to be critical to reliable operation, decision 588 steers program flow to function where appropriate flags are set and messages which provide an indication of failure status are provided, including, when possible, a “SHUT DOWN” warning. LIH 160 is then returned to a null state at exit 592 which requires reentry at oval 580 to begin again.

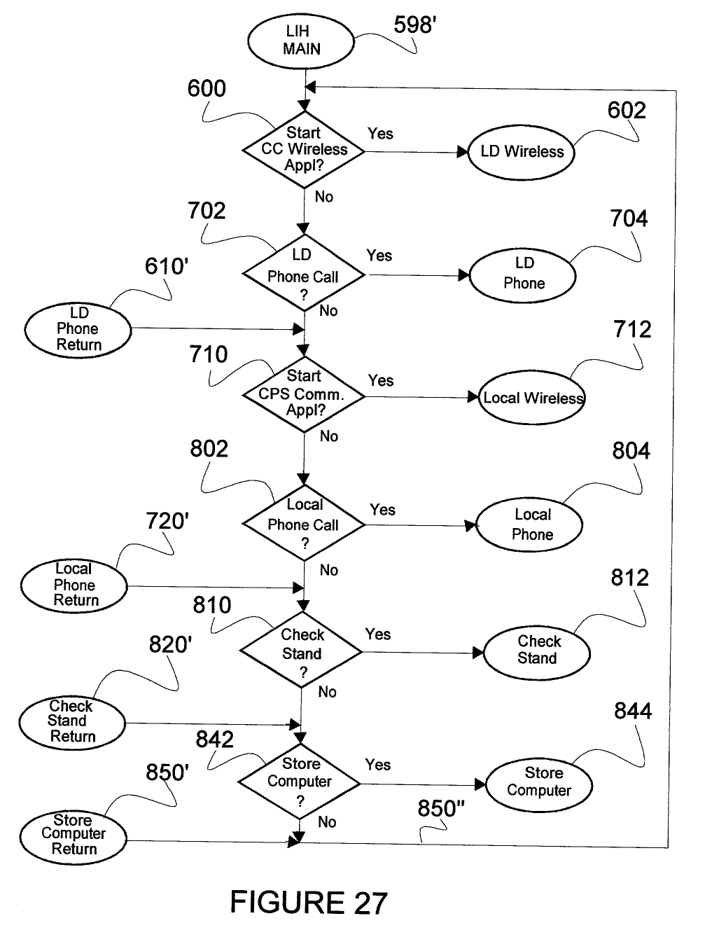

If any and all failures are not critical to reliable operation, a flag is set in a status file for future review by function 594 and Windows CE multitasking operation is begun by function 596. Also, a positive determination by decision 586 results in action by function 596. From function 596 program flow passes through oval 598 to oval 598′ (see FIG. 27).

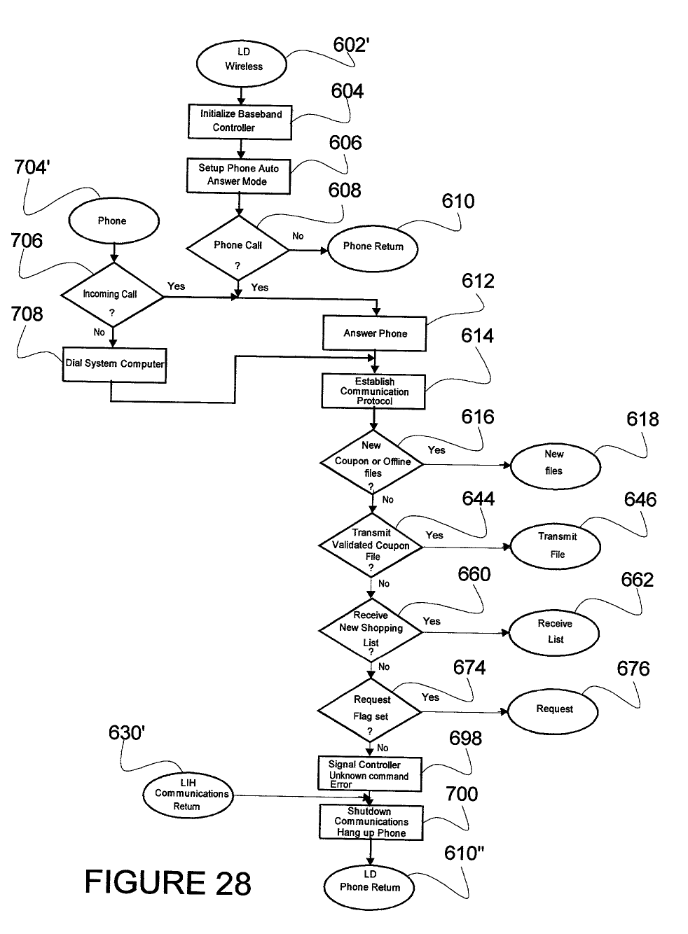

As list insertion hub 160 communicates with at least two entities which may be remotely disposed relative to LIH 160, two separate communicating programming routines apply. Therefor, decision 600, following oval 598′, tests a central controller communications initiation flag which, if set, steers program flow to oval 602 and to oval 602′ (see FIG. 28). Thereat, function 604 initializes baseband controller 492 (see FIG. 16) and function 606 sets a phone auto-answer mode for incoming calls from central controller 110.

Decision 608 tests to determine whether or not there is a call waiting. If not, long distance (LD) phone return oval 610 returns operation through oval 610′ to the main loop of FIG. 27. Otherwise, function 612 answers the incoming phone call, and function 614 establishes communication protocol which initiates the next operating mode.

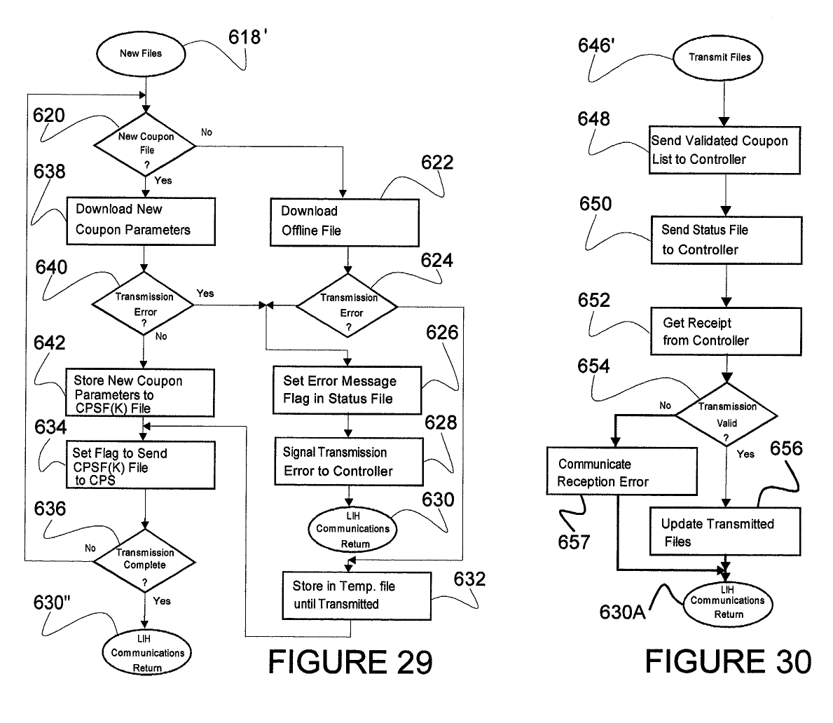

Decision 616 tests for a download request from controller 110. If there is such a download request, oval 618 steers flow to oval 618′ of FIG. 29. While other files or commands may be downloaded from controller 110 to LIH 160, those which are most germane to the present invention are changes, additions or other amendments to coupon files (i.e. CPSF(k)) and are advertising related files. Decision 620 steers program flow to function 622 for downloading advertising files (otherwise referenced, herein, as offline files). Any transmission errors are detected by tests which are well known and commonly used in the digital communication art. If a transmission error is discovered (by decision 624), function 626 sets an appropriate status file flag and function 628 signals the transmission error to controller 110. Flow from function 628 is through oval 630 to oval 630′ of FIG. 8.

If no transmission error is detected by decision 624, function 632 stores received data in a temporary file awaiting transmission to coupon processing station 10. Next, function 634 sets a flag to transmit the temporary file to coupon processing station 10. Subsequent decision 636 determines whether or not transmission from controller 110 is complete. If so, program flow is to oval 630″ and, like oval 630, to oval 630′. If not, program flow returns to decision 620.

If decision 620 determines data sent involves coupon parameters, function 638 receives the new parameters. Decision 640 tests validity of transmitted data. If an error is detected, program flow is to function 626 for processing as earlier disclosed. If no transmission error is detected, function 642 stores received data in an appropriate coupon parameter file (e.g. a CPSF(k)). Subsequently, program flow is to function 634 which sets a flag for transmission of the newly received data to coupon processing subsystem 120 and continues to decision 636, as earlier disclosed.

Referring once more to FIG. 28, a “no” determination by decision 616 directs program flow to decision 644 which tests for a polling request by controller 110 to transmit information stored by LIH 160. Such information includes, but is not limited to, a record of validated coupons since last requested transmission and status files of both LIH 160 and subsystem 120. Of particular interest is the record of validate coupons. Such should have been previously sorted by coupon originator and be tagged for easy recording and ready accumulation with like records received from other subsystem 120's. Accumulated records are finally organized for subsequent transmittal to coupon originators for remuneration to redeeming establishments and to an operator of system 100 for coupon processing services provided.

In this matter, decision 644 steers program flow through oval 646 to oval 646′ (see FIG. 30). Responsive to request, LIH 160 transmits a current sorted list of validated redeemed coupons per function 648. The above mentioned status files are transmitted via function 650. Function 652 receives a message regarding logical validity of transmitted data between controller 110 and LIH 160. Decision 654 tests validity of transmitted data. If valid, function 656 confirms validity of the transmission and initializes transmitted files for new data accumulation and program flow proceeds to oval 630A for continuation to oval 630 (see FIG. 28). If transmission is invalid, decision 658 steers program flow to function 657. Function 657 sets a transmission error flag in the status file for subsequent response to controller 110. From function 657 program flow is through oval 630A to oval 630′ (FIG. 28). Note, that it is an assigned responsibility of polling controller 110 to poll again when data transmitted is invalid.

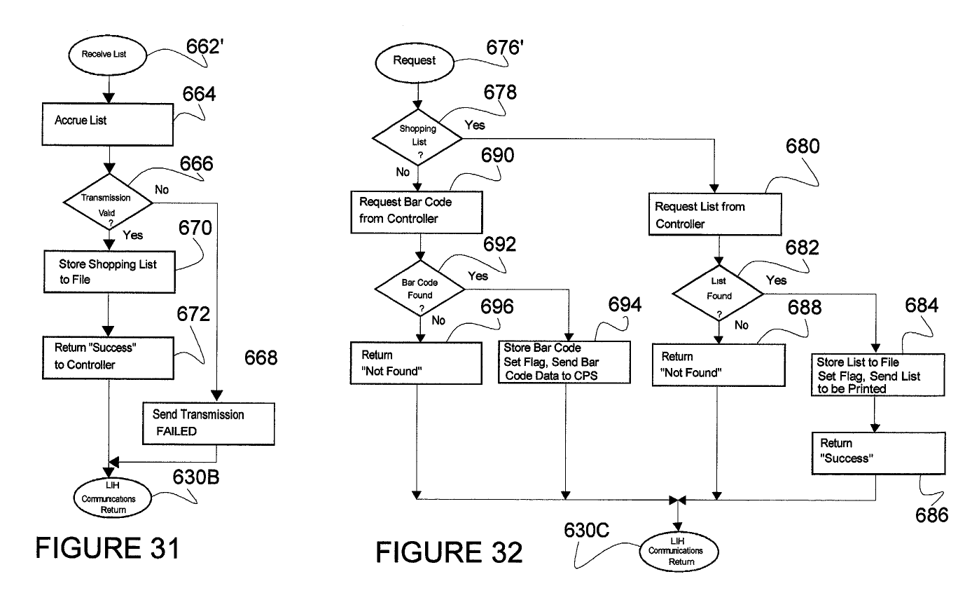

Referring again to FIG. 28, a “no” determination by decision 644 leads to a next decision 660, which is related to downloading a controller 110 originated coupon shopping list 300 from controller 100 for use in the establishment where this LIH 160(s) is disposed. A “yes” determination by decision 660 steers flow through oval 662 to oval 662′, seen in FIG. 31. Note that this is not a result of a polling communication (see FIG. 29), because transmission of such controller originated lists requires availability at the receiving LIH 160 as soon as possible to satisfy customer use requirements.

Function 664 receives the controller 110 contained list and subsequent decision 666 tests logical validity of transmitted data. If the transmitted data is not valid, function 668 generates a “transmission failed” message response to controller 110 and program flow continues to oval 630B and to oval 630′ (see FIG. 28). As earlier stated, responsibility is left with message originating controller 110 to resend if transmission fails.

Upon successful transmission, function 670 assigns a “j” address to received shopping list 300. Function 672 signals “success” to controller 110. As before, exit is via oval 630B to oval 630′ of FIG. 28.

Cases which require a request from LIH 160 to controller 110 include a search for a coupon shopping list bar code 320 not currently stored in LIH 160 or coupon processing station 10 memory and another search for a coupon bar code parameter storage file not being addressable by a coupon bar code read at station 10. Both cases result in a request flag being set and responded to by decision 674 to direct program flow through oval 676 to oval 6761 (see FIG. 32).

Decision 678 parts program flow to function 680 when the request is for an electronically stored shopping list which may be stored in or available through controller 110. Function 680 sends a request to controller 110 for the specific list based upon a bar code entered by reading a not locally-stored coupon shopping list 300 bar code 320 at a station 10. If such a list is found in controller 110 (decision 682), function 684 receives the list and assigns a “j” address to the list and stores a record of a CSL(j) in memory for further use. Function 686 sends a “list found” message to an associated station 10 for instruction to a consumer who entered a shopping list 300 which initiated the search. Otherwise, a “list not found” message is sent to station 10 (function 688). Exit is through oval 630C to 630′ (see FIG. 28).

If the request is for a coupon bar code, function 690 requests immediate transmission of a corresponding coupon parameter storage file from controller 110. Decision 692 determines whether or not the file is successfully found and received. If so, function 694 assigns a “k” address to the received file, stores the file as CPSF(k) and transmits the file to station 10 to satisfy a need originated at station 10. If not, a “not found” message is transmitted to station 10 (function 696) which results in rejecting a coupon having the found bar code which was not found in any system 100 file. From function 694 and 696, program flow exist via oval 630C to oval 6301 in FIG. 28.

Function 698, which follows a “no” determination by decision 674, signals controller 110 that no bonafide operational command has been received. Both function 698 and oval 630′ proceed to function 700 which shuts down communication routines, hangs up the phone and steers flow through oval 610″ to oval 610′, found in FIG. 27.

Referring once more to decision 600 in FIG. 27, a “no” determination steers flow to decision 702 which responds to a flag indicating a long distance phone call. If the flag is set, program flow proceeds through oval 704 to oval 704′ (FIG. 28).

Next decision 706 determines whether or not the call is incoming. If so, program flow continues to function 612 and therefrom as previously described. If not, function 708 dials and connects for data transmission with controller 110 and flow continues to function 614 to follow paths earlier disclosed.

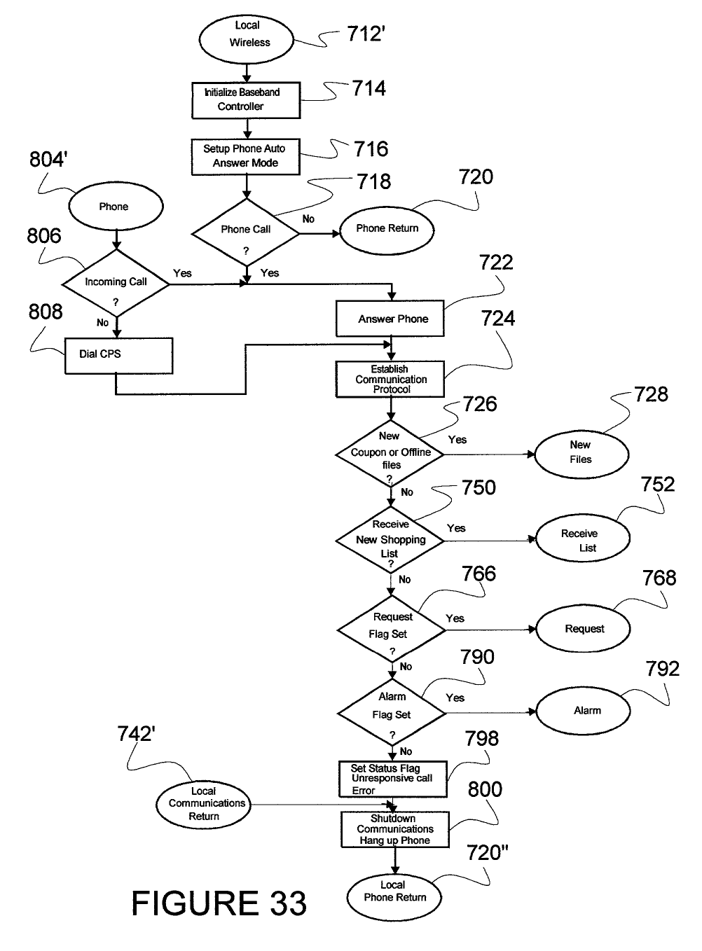

A “no” determination by decision 702 (FIG. 27) steers program flow to decision 710 as does entry through oval 610′. As earlier related, LIH 160 potentially has two system 100 communication modalities, long distance with controller 110 and local with coupon processing station 10. Decision 710 determines whether or not a local communication is to be begun by testing flags set to determine prior local communication status and a request to start a local communication regimen. If so, decision 710 steers program flow through oval 712 to 712′ (see FIG. 33).

Thereat, function 714 initializes baseband controller 258 (see FIG. 16) and function 716 sets a phone auto-answer mode for incoming calls from coupon processing station 10.

Decision 718 tests to determine whether or not there is a call waiting. If not, long distance (LD) phone return oval 720 returns operation through oval 7201 to the main loop of FIG. 27. Otherwise, function 722 answers the incoming phone call, and function 724 establishes communication protocol and sets a flag for the next operating mode.

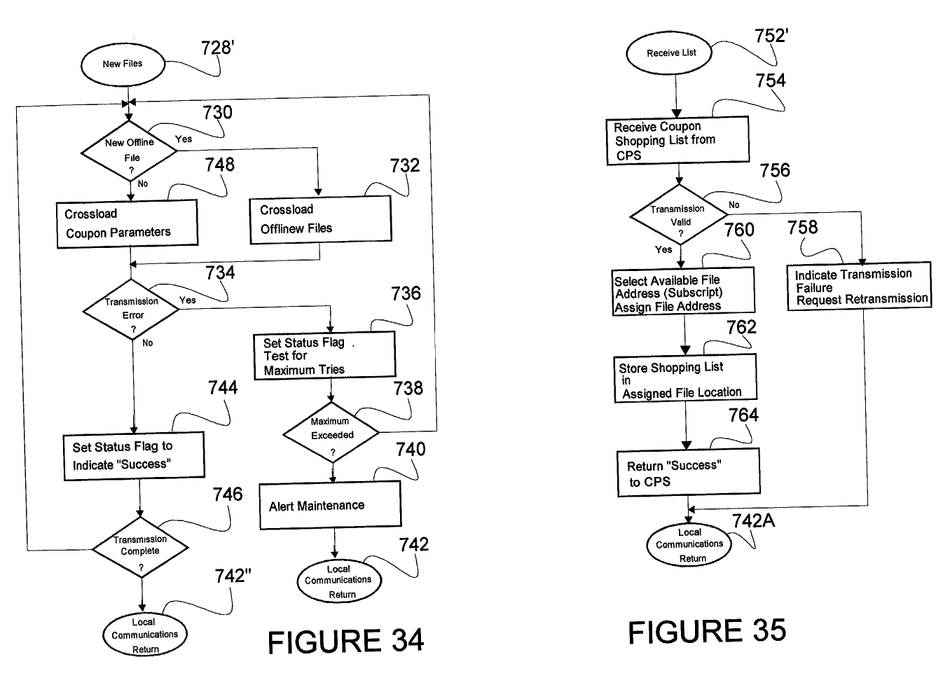

Decision 726 tests the next operating mode flag for a crossload request. If there is such a flag, oval 728 steers flow to oval 728′ of FIG. 34. While other files or commands may be crossloaded from LIH 160 to coupon processing station 10, those which are most germane to the present invention are changes, additions or other amendments to coupon files (i.e. CPSF(k)) and are advertising related files.

When the request is for transmission (crossloading) of advertising related files (herein, sometimes referred to as offline files), decision 730 steers program flow to function 732. Function 732 crossloads the requested files. Any transmission errors are detected by tests which are well known and commonly used in the digital communication art. If a transmission error is determined (decision 734), function 736 sets an appropriate status file flag and a test for a maximum number of tries for each file transfer. Decision 738 determines whether or not the maximum number of allowed tries has been exceeded. If not, program flow is steered to decision 730 to continue. If the maximum number of tries has been exceeded, function 740 sets a critical flag in the status file for maintenance to be alerted and performed. This flag is consequently passed to controller 110 for action. From function 740 program flow passes through oval 742 to oval 742′ of FIG. 33.

If no transmission error is detected at decision 734, function 744 sets flag to success. In this case of transmitting an offline file, that offline file is removed from temporary storage in LIH 160. Decision 746 tests for completion of all transfers for this call. If other transfers are to be made, program flow returns to decision 730. Otherwise, program flow continues through oval 742″ to oval 742′, found in FIG. 33.

If decision 730 steers program flow to crossload coupon parameters as dictated by controller 110 in a prior transmission to LIH 160, function 748 crossloads applicable coupon parameter files along with a “k” address to station 10. Such coupon parameter files are destined to be stored in a new CPSF(k) in station 10. However, before storage in any operational memory of station 10, decision 734 checks transmission validity. If transmission is invalid, program flow continues to function 736 and therefrom as previously disclosed. However, if transmission is successful, function 744 completes the successful transmission cycle and transmitted files are stored in CPSF(k). Program flow then continues to decision 746 as earlier disclosed.

Referring to FIG. 33 once more, a “no” determination by decision 726 steers program flow to decision 750 which steers program flow to oval 752 then to oval 752′ (FIG. 35) if a new coupon shopping list generated at station 10 is being transmitted to LIH 160. Function 754 receives the new coupon shopping list 300 and stores the list 300 in a temporary file. Decision 756 tests the transmission for validity. If there has been an error in transmission, program flow is steered to function 758 which records a transmission failure flag in the status file and sends a request for retransmission to station 10. Next, program flow exits through oval 742A to 742′, seen in FIG. 33.

If decision 756 determines the transmission to be valid, function 760 selects a subscript “j” which is assigned to a coupon shopping list 300. Note that subscript “j” should be referenced to bar code portion 324 of bar code 320 of shopping list 300. Function 762 then stores list 300 in CSL(j). Function 764 signals successful receipt of the shopping list and exit is also made through oval 742A to oval 742′.

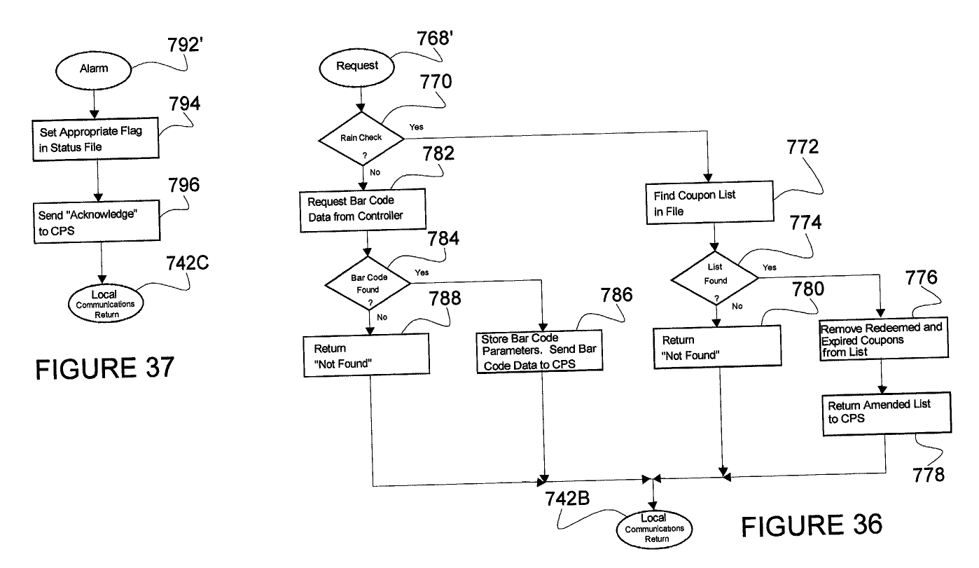

A “no” determination by decision 750 (FIG. 33) steers program flow to decision 766. Decision 766 is responsive to file requests from station 10. If a file request has been made flow is steered through oval 768 to oval 768′ (see FIG. 36). Though there may be other operational file requests made by station 10 to LIH 160, requests disclosed herein are important to operation of the instant invention. These requests are for bar codes not found in any CPSF(k) file and for a coupon shopping list 300 identified by a bar code reading at station 10 and not contained in memory therein. As an example, such a case would be for the creation of a supplemental coupon shopping list 300 from an original coupon shopping list 300 with used or expired coupons removed for use at a later time.

Decision 770 determines whether the request is for an unspent or “rain check” printing of an existing coupon shopping list 300 or if the request is for a file for a coupon bar code not found in a station 10 file. If the determination is for an unspent or “rain check” list 300, function 772 searches for such a CSL file in LIH 160. If such does not exist, a request is made to controller 110 for the list. Upon completion of the searches, decision 774 determines whether or not such searches are successful. If so, function 776 processes the list to remove redeemed and expired coupons which may no longer be used. The edited list is then sent to station 10 (function 778). If decision 770 determines no such list is found, function 780 returns a message of “Not Found” to station 10. Both functions 778 and 780 exit through oval 742B to oval 742′ (FIG. 33).

If decision 770 is negative, a request is interpreted to be from station 10 for a coupon parameter storage file for a bar code read in a bar code reader 278 (see FIG. 6), but for which there is no CPSF(k) data available in station 10. It is anticipated that a request will resultingly be made to controller 110 for such a CPSF(k), where k is a subscript representing a file address ultimately assigned to the file. Function 782 processes the request. Decision 784 assesses success achieved by function 782. If a coupon parameter file is found within system 100, decision 784 directs program flow to function 786 where a derived CPSF(k) is delivered to station 10. Otherwise, a “not found” message is sent to station 10 (function 788). In both cases, exit is made to oval 742′ (FIG. 33) via oval 742B.

As station 10 and LIH 160 operate in a remote environment from a central control office, timely maintenance is important. For this purpose, a series of tests should be constantly performed on both subsystems. From decision 766, program flow continues to decision 790 which, if an alarm is set, steers operation through oval 792 to oval 792′ of FIG. 37.

Alarms include, but are not limited to, a call for providing a printer paper refill. From oval 792′, function 794 sets an appropriate flag in the status file of LIH 160 for subsequent transmittal of the alarm to central controller 110. Subsequent function 796 transmits acknowledgment of receipt of the alarm to station 10 and program flow returns through oval 742C to oval 742′ (see FIG. 33).

If no “yes” determination is made by any decision 726, 750, 766 or 790, a status flag is set by function 798 indicating an unresponsiveness to the request made through function 724. Program flow through oval 742′ and function 798 joins at function 800 which ends local communications and effectively performs a phone hang up command. Program flow continues through oval 720″ to oval 720′ seen in FIG. 27.

A “no” determination made by decision 710 steers program flow to decision 802 which ascertains whether or not a local phone call connection is requested. If so, decision 802 steers program flow through oval 804 to oval 804′ of FIG. 33. Subsequent decision 806 determines whether or not the call connection request is incoming or outgoing. If the request is incoming, program flow is steered to function 722 and onward as earlier recited. If the request is outgoing, function 808 dials coupon processing station 10 communications link and program flow continues to function 724 and onward as earlier disclosed.

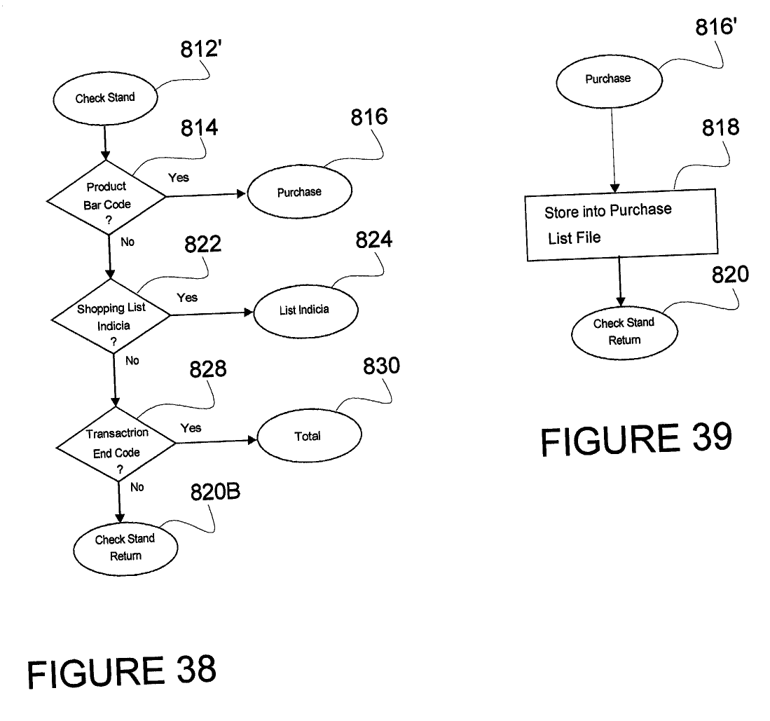

Referring once more to FIG. 27, a “no” determination by decision 802 and return through oval 720′ steers flow to decision 810 which assesses whether or not a check-stand 500 communication is to be processed. Such processing occurs each time a product bar code is read and transmitted to a store computer 520 and each time any other command or data transmittal occurs from each check-stand 500(e) to store computer 520. Occurrence of such a communication causes program flow to pass through oval 812 to oval 812′ of FIG. 38.

Operation of LIH 160 is varied as is determined by the type of data being transmitted from each check-stand 500(e). If the data being transmitted is a product bar code, decision 814 directs processing through oval 816 to oval 816′ of FIG. 39. Thereat, function 818 accumulates and stores each such product bar code in a temporary file (e.g. a temp file 550(e)) established for each check-stand 500(e). This file retains all relevant data for each sales transaction in progress at check-stand 500(e) until the transaction in progress is completed. Upon completion of function 818, program flow returns to FIG. 27 from oval 820 to oval 820′.

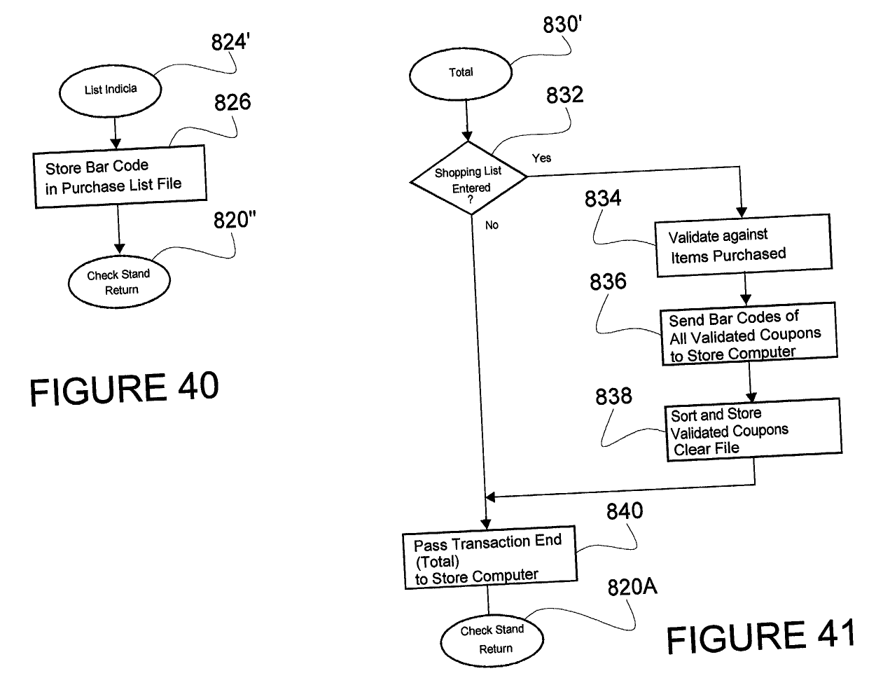

If the communication is determined to be shopping list 300 indicia (in this case bar code 320), decision 822, FIG. 38, following a “no” determination by decision 814, directs flow through oval 824 to oval 824′ of FIG. 40. Function 826 stores bar code 320 in the temporary file (in this example, temp file 550(e)). Flow continues through oval 820″ to oval 820′ of FIG. 27.

Referring to FIG. 38, a “no” determination by decision 822 results in decision 828 sensing whether or not the communicated data is a transaction ending code (i.e. a “TOTAL” command). A sensed TOTAL command steers program flow through oval 830 to oval 830′ of FIG. 41. Affirming a product (or products) sale against a bar code of a coupon referenced from a coupon shopping list 300(k) stored in temp file 550(e) validates use of that coupon. After such validation, the bar code of the validated coupon is sent to connected store computer 520 for processing in the same manner any coupon read at a check-stand(e) is processed without a subsystem 110.

And so, from oval 830′, decision 832 determines whether or not a shopping list bar code has been stored in the temporary file associated with this transaction (by example, in this case, in temp file 550(e)). If a shopping list bar code 320(j) is found in the temporary file, function 834 validates all coupons identified by bar codes in the coupon shopping list 300(j) against purchases identified by product bar codes in the same temp file 550(e). Function 836 transmits the bar code of each validated coupon to store computer 520. Function 838 sorts every validated coupon into a stored file for later transmittal to controller 110.

If decision 832 deciphers that no list 300 has been read at check-stand(e) or at the completion of function 838, function 840 passes TOTAL to store computer 520. Temp file 500(e) is cleared and initialized for a new transaction at check-stand(e). Program flow returns to FIG. 27 from oval 820A to 820′.

It should be noted, that the TOTAL command is trapped to eliminate a possibility of a race condition which may occur if TOTAL is processed by store computer 520 before all coupons have been validated and bar codes of validated coupons have been passed from LIH 160 to store computer 520. If store computer 520 has a program modification which causes store computer 520 to wait for all validated coupon bar codes to be received from LIH 160 before completing a transaction and sending totals and printing commands to check-stand(e), the TOTAL command does not have to be trapped by LIH 160.

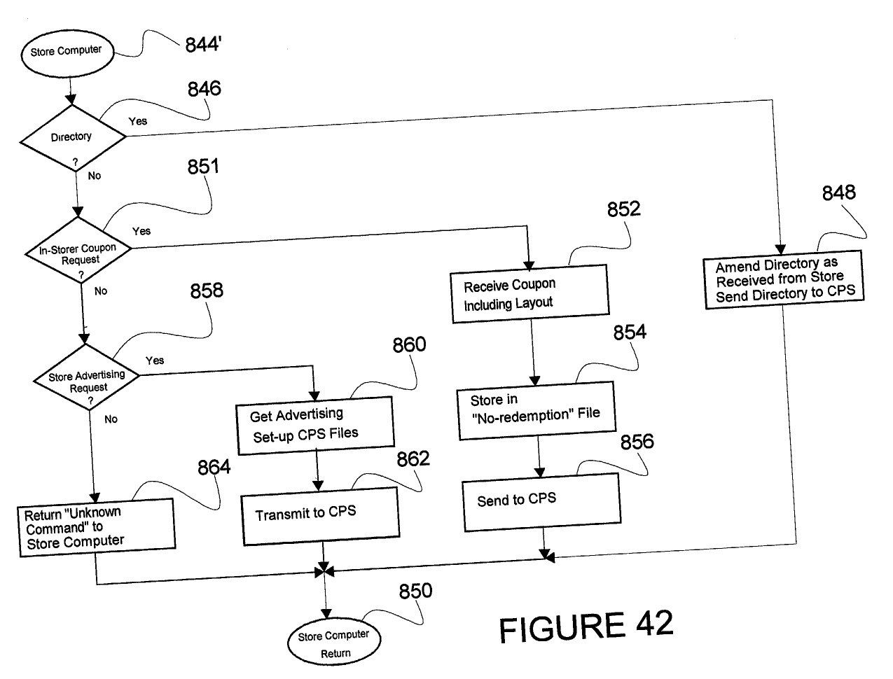

A “no” determination by decision 828 (FIG. 38) steers program flow through oval 820B to oval 820′ (FIG. 27) where along with a “no” determination by decision 810 program flow is steered to decision 842 which tests for a communication request from store computer 520. If a store computer 520 request is being made, program flow is through oval 844 to 844′ of FIG. 42.

Communications from a store computer 520 to an LIH 160 comprise modes of:

1. Setting up in-establishment advertising on coupon processing station 10.

2. Receiving amendments and additions to in-establishment coupons to be processed at station 10.

3. Amending the in-establishment store directory as used in station 10 coupon shopping list 300 and other graphical display 22 (see FIG. 6) functions.

A “yes” determination, to a directory query, by decision 846 steers program flow to function 848. Under control of function 848 and a related program resident in store computer 520, a directory file contained in LIH 160 is amended. The amendment to the directory file is then forwarded to associated station 10. Return, following function 848, is through oval 850 to oval 850′ of FIG. 27. Note, in FIG. 27, that all returns through oval 850′ and a “no” determination by decision 842 causes program flow to recycle to decision 600 to continue the LIH 160 main programming loop as indicated by line 850″.

If a determination of decision 846 is not “yes”, a subsequent determination is made by decision 851 regarding whether or not the query concerns modifications of in-establishment coupons stored and processed in station 10. If so, function 852 receives the continuing communication which produces additions and amendments to coupons and coupon layout, function 854 stores data from the continuing communication for later use in coupon validation (see FIG. 41) and function 856 sends all applicable data from the communication to coupon processing station 10. Note that there is no need for redeeming coupons from a third party CO for in-establishment coupons. However, it is considered prudent to provide the establishment with a report of validated in-establishment coupons. Program flow from function 856 is through oval 850 to oval 850′.

If a “no” assessment is made by decision 851, decision 858 tests for a store advertising query initiated by store computer 520. If a “yes” determination is made, function 860 and a corresponding program disposed in store computer 520 communicate advertising programs, schedules and other data associated with the request to LIH 160. Such computer inter-communicating programs are well known in the computer inter-communications art. Function 862 transmits a relevant advertising data to coupon processing station 10. Program flow from function 862, like program flow from function 856 flows through oval 850.

As an example, if program flow passes through decisions 846, 851 and 858 without a “yes” determination, function 864 transmits san “unknown command” response to store computer 520. Program flow returns through oval 850 to oval 850′ of FIG. 27.

The Central Controller and Interfaces to LIH, CO's and PC's

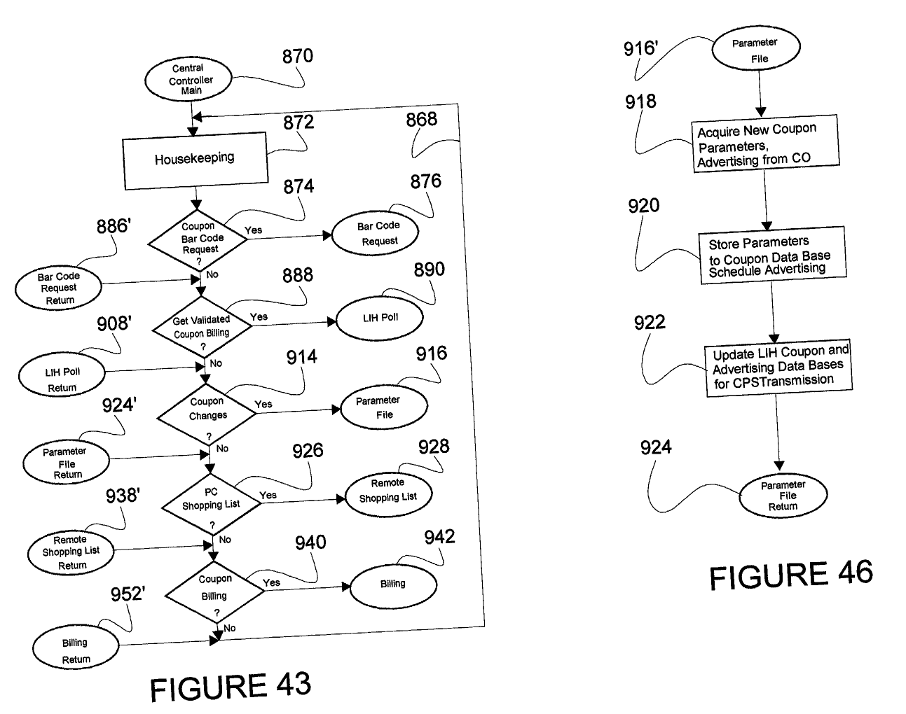

Reference is now made to FIGS. 43-49. A program flow diagram of a main operational controller 110 loop 868 is seen in FIG. 43, beginning at entry oval 870. Function 872 performs general housekeeping including system 120 autoloading. Such housekeeping and autoloading functions are well known in operating system and related computer programming art.

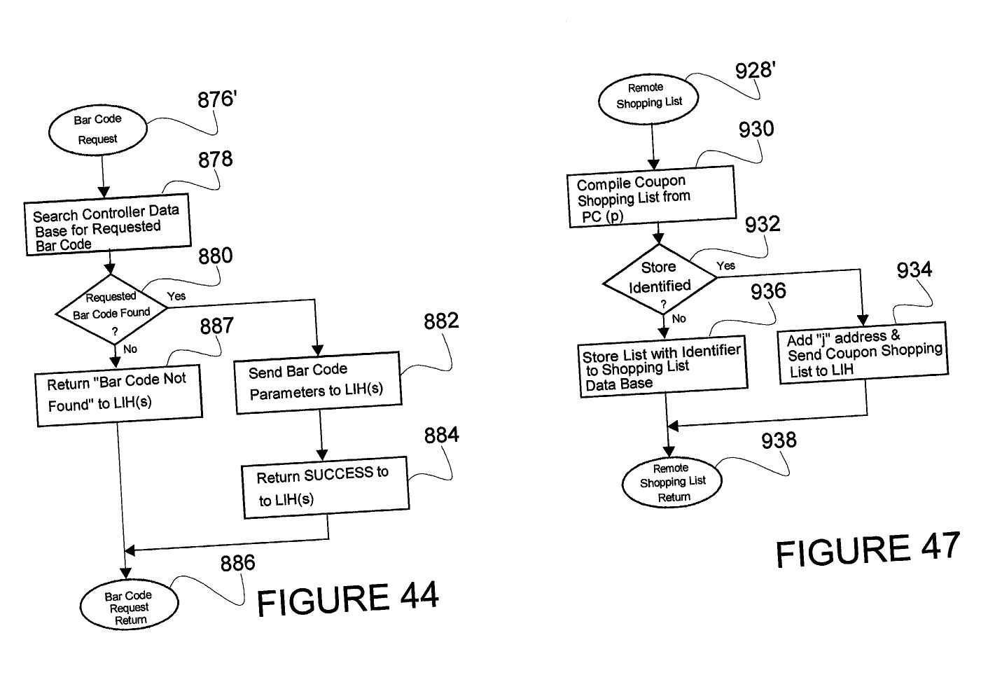

Initial decision 874 of loop 868 determines whether or not a request for a coupon bar code has been received from a particular LIH 160(s). If there is such a request, program flow is steered through oval 876 to oval 876′ of FIG. 44. It is anticipated that such a request is the result of reading a coupon bar code at a coupon processing station 10(s) whereat parameters of this coupon bar code are not on file in the particular LIH 160(s). Such a request is generated by LIH 160(s). Responsively and timely, controller 110 searches all related files for the requested coupon bar code, function 878.

If the search is successful, function 882 responsively transmits parameters associated with the requested coupon bar code to LIH 160(s) for further transmittal to station 10(s). A confirming message of utility of the parameters is also sent, function 884, to assure security of use. Otherwise, function 887 returns a “not found” message to LIH 160(s). Exit is through oval 886 to oval 886′, FIG. 43.

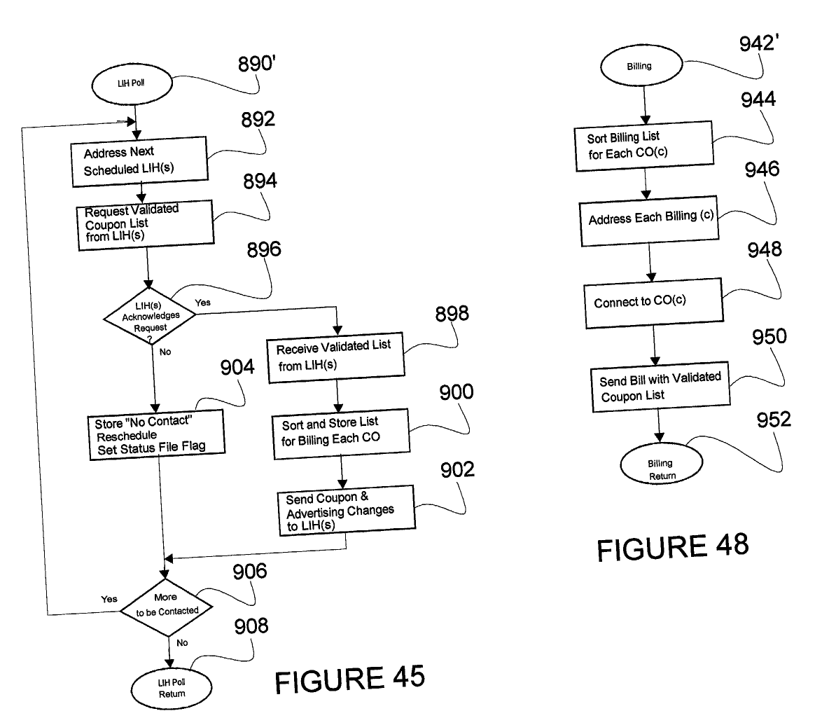

At predetermined times, based upon geography and coupon processing activity, each LIH 160(s) is polled for coupon validation and billing data. Decision 888 determines time of entry into such a polling routine for each selected LIH 160(s). Entry into the polling routine is through oval 890 to oval 890′, FIG. 45, and follows oval 886′ or function 874.

Function 892 selects a particular LIH 160(s). Function 894 initiates a communication of a message requesting a list of validated coupons from the selected LIH 160(s). Decision 896 determines whether the communication is acknowledged by the selected LIH 160(s). If the communication is acknowledged, function 898 receives and stores the list of validated coupons from the selected LIH 160(s). Function 900 sorts and stores contents of the validated coupon list for later billing transmission to each coupon originator (CO), as appropriate. Such billing generally follows rules established by each individual CO. Function 902 follows receipt of the validated coupon lists with a transmission of changes and updating of coupon parameters and centrally scheduled advertising to the selected LIH 160(s) and with a message which permits LIH 160(s) to initialize files associated with such billing transmissions.

If no communication is acknowledge, function 904 stores a record of inability to make contact and reschedules communication with the selected LIH 160(s) for a later time. A status flag is set for maintenance purposes, should future contact be unreasonably delayed. Both functions 902 and 904 exit through decision 906. Should it be desired to communicate with an additional LIH 160, decision 906 steers program flow to function 892. If no further contact is scheduled with another LIH 160, exit is made through oval 908 to oval 908′, FIG. 43.

While coupon changes may be made by receiving printed coupons, facility for electronic transmission of coupons and coupon parameters, provides for far more dynamic sales and marketing strategies than is currently possible. As an example, immediately after generation, a Co may send a coupon and associated parameters to controller 110. In a next transmission, controller 110 sends the coupon and associated parameters to each LIH 160 as directed by the CO and edits and otherwise changes coupon parameters as the CO desires. In this manner, dynamics of coupon marketing is dramatically changed.

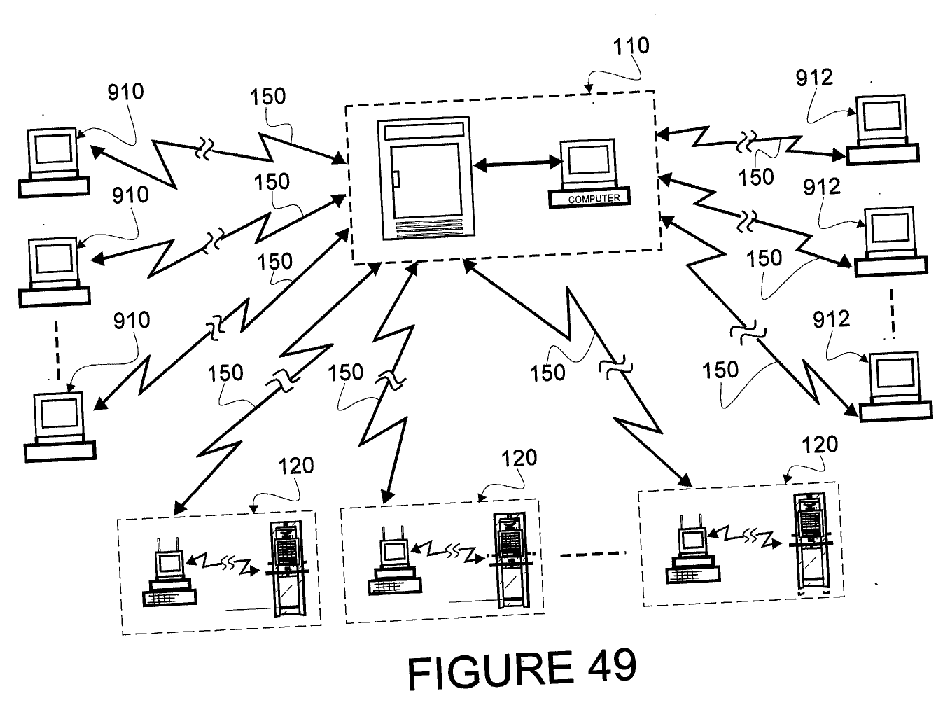

Reference is now made to FIG. 49 wherein schematic block diagram representations of controller 110; a plurality of coupon processing subsystems 120, a representation of a number of coupon originator work stations, generally numbered 910; and another number of personal computers, generally numbered 912 are interconnected, as seen, by interconnecting phone (i.e. Internet, RF, etc.) links 150. See FIGS. 3-5 for additional details of subsystems 110 and 120.

Contemporary communications products may be employed for baseband controller 492 and RF subsystem 494 (see FIGS. 16 and 25) which communicate over links 150. As an example, Intel PRO/wireless LAN 2011B may be used, as well as products available from Bluetooth. Such products for wireless LAN or WAN should meet IEEE Standards 802.11A or 802.11B.

Also for system 100 locally oriented communications, Zircom Eagle II, a self contained global system may be employed for local baseband controller 258 and local RF controller 164 (see FIGS. 6 and 16). All such RF subsystem and baseband controller products interface with StrongARM SA-1110 processor which may be used for micro processor 250.

A major consideration of communications between subsystem 110 and 120 and CO work stations 910 is security of data transmission. It is critical to CO's that security of all such information be strictly maintained. As it is understood that processing of coupons from a CO may involve millions of dollars in transactions and that competitors of each CO may engage in industrial espionage, security of information contained in all files and other documents sent from each CO work station 910 over the Internet to controller 110 must be held in secrecy until released by the CO for publication. That security and privacy must prevail over all individuals not authorized access by a CO, including all personnel directly associated with system 100. Further, for system 100 to be used as a billing system for validated coupons, all communications between each subsystem 120 and subsystem 110 and therefrom to a CO must be secure.

For this reason, it is recommended that an SSL or similar security process be employed. As a part of the SSL security, the browser of a communicating computer is supplied with a public encryption code. An icon indicating that secure transmission has been established is graphically displayed for use during manual transmissions. Such transmissions may be secured by use of public/private security keys. One method of generating public/private security keys is through the use of a PGP security key defining program. Though other methods for defining security keys may be used, it is critical to note that the likelihood of attack should be considered when selecting any security defining system. Various modes of security protection should be employed to provide for the following:

1. privacy of all CO originated coupon and coupon parameter material until released for publication by a CO.

2. assurance that all coupon data is maintained in its original state throughout use on system 100.

3. veracity and security of all billing data.

To provide for this wide range of protection, all critical files originated by each work station 910, subsystem 110 and subsystem 120 for communication with a system 100 component should be encrypted with a public key of the sending entity. Each receiving entity must then have a private key to profitably use of any transmitted files.

With such considerations in place, reference is again made to FIG. 43 wherein decision 914 steers program flow through oval 916 to oval 916′ (see FIG. 46) for communicating coupon parameters sent from a CO to controller 110. Therein function 918 receives new coupon data, including but not limited to new coupons, deleting previously available coupons and amending coupon parameters of coupons currently on file. In addition, any relevant new or edited advertising files are also communicated. All such communications should be privacy protected.

Function 920 stores received parameters in a coupon master file and stores advertising as specified by the requesting CO. Function 922 schedules all received files and other data for transmission to each LIH 160(s). Loop 868 is reentered via oval 924 to oval 9241 of FIG. 43.

If a coupon shopping list 300 is remotely generated, for example, by a personal computer 912, decision 926 steers program flow through oval 928 to oval 928′ (see FIG. 47). Function 930 produces a coupon shopping list 300 in much the same manner a coupon shopping list 300 is generated by station 10, although it should be anticipated that a personal computer 912 operator will likely use a mouse rather than a touch panel. Operator of personal computer 912 is given an option of identifying or not identifying a store in which the coupon shopping list 300 will ultimately be used. If the operator selects an establishment where the coupon shopping list 300 is to be used, decision 932 steers program flow to function 934 where a “j” address 324 and an “s” address 322, associated with CSL(j) and with station 10(s), respectively, are combined to make bar code 320 and sends a so identified shopping list 300 to LIH 160(s). Otherwise, function 936 stores the shopping list with a controller 110 address 322 to satisfy a future access LIH 160 request for such information to be sent from controller 110. Both functions 934 and 936 exit via oval 938 to oval 938′ of FIG. 43.

Final decision 940 of FIG. 43 steers program flow through oval 942 to oval 942′ of FIG. 48 when billing of responsible CO's is in process. Billing information is derived and accumulated and then sorted from each LIH 160, see FIG. 45. To communicate a bill efficaciously each billing list received via functions 898 and 900 may be combined with other like billing lists for a comprehensive billing. However, care should be taken to observe and follow instructions of each individual CO. Also, each individual establishment must be credited and remunerated appropriately. With this in mind, function 944 sorts and accumulates billings for each CO(c). Function 946 compiles the billings and addresses each CO compilation. Function 948 connects to a CO work station 910, when billing is via electronic wire transfer, otherwise billing is printed addressed and stamped. Function 950 sends each billing to the appropriate CO. Oval 952 returns program flow through oval 952′ of FIG. 43. Program flow from oval 952′ and a “no” determination by decision 940 follow loop 868 to function 872.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

What is claimed and desired to be secured by Letters Patent is:

1. A coupon processing system whereby, compared with contemporary processes, activity associated with redeeming coupons at product indicia reading cash registers is reduced and other activity associated with sorting and handling of redeemed coupons by a retail establishment applying for a refund from coupon originators is also reduced, said system comprising:
an in-establishment coupon processing subsystem comprising:
a coupon processing station comprising coupon entry apparatus by which at least one coupon is identified and selected for addition to a coupon shopping list by action of a station user, said station further comprising a digital processor wherein a record of identifying indicia of each selected coupon is retrievably stored for later access and a printer which produces a printed copy of the coupon shopping list, the list comprising a uniquely identifiable code disposed thereon which is read by product indicia reading cash registers employed by the retail establishment for the purpose of accessing a record of redeemable coupons at the time of a sales transaction;
a list insertion hub comprising a digital processor having a communications link to the product indicia reading cash registers and to a central transaction processing computer which receives and processes product indicia of each item being purchased;
said list insertion hub further comprising a communications link with the coupon processing station whereby the record associated with each coupon shopping list and the uniquely identifiable code for that shopping list are communicated from the coupon processing station to the list insertion hub;
said list insertion hub processor further comprising an operating mode which records, as a separate list, items purchased during each transaction at each of the cash registers and which records and correlates the uniquely identifiable code read from the coupon shopping list which was previously as a guide, whereby one or more items imprinted on the list was selected for coupon redemption, and which validates all coupons for which items meet coupon redemption requirements and which transmits identifying indicia for validated coupons to the central transaction processing computer;
a controller, remotely disposed relative to the retail establishment, wherefrom definitive coupon identification, redemption parameter are transmitted to the in-establishment coupon processing subsystem; and
said in-establishment coupon processing subsystem further comprising an operational mode whereby records of validated coupons are accumulated and transmitted to said controller.

2. A coupon processing system according to claim 1 wherein said coupon processing station digital processor and said list insertion hub digital processor are the same digital processor.

3. A coupon processing system according to claim 1 wherein said entry apparatus comprises a graphics display.

4. A coupon processing system according to claim 3 wherein said graphics display is a flat panel display.

5. A coupon processing system according to claim 1 wherein said entry apparatus comprises a bar code reader.

6. A coupon processing system according to claim 1 wherein said uniquely identifiable code comprises a bar code.

7. A coupon processing system according to claim 1 wherein said list insertion hub communications link with the coupon processing station comprises a wireless cell phone link.

8. A coupon processing system according to claim 1 wherein said list insertion link to the product indicia reading cash registers and to the central transaction processing computer is an Ethernet link.

9. A coupon processing system according to claim 1 wherein said controller comprises a mode of operation whereby coupon originators are billed via Internet wire transfer for direct payment to an account of the establishment.

10. A coupon processing system according to claim 1 wherein said coupon processing station further comprises a user identification reader.

11. A coupon processing system according to claim 10 wherein said identification reader is a magnetic strip reader.

12. A coupon processing system according to claim 1 wherein said coupon processing station further comprises a motion detector whereby any current operational mode is switched to a user service mode as a approaching user is detected.

13. A method for processing redeemable coupons at a retail establishment comprising the steps of:
providing an in-establishment coupon processing subsystem comprising:
a coupon processing station comprising a digital processor, coupon entry apparatus and a printer;
a list insertion hub which comprises a communicating data link to the coupon processing station;
providing a controller remotely disposed from the in-establishment coupon processing subsystem, but having a communicating data link thereto;
installing the in-establishment coupon processing subsystem in a retail establishment having product indicia reading cash registers and an associated central transaction processing computer;
establishing a communicating data link which permits the list insertion hub to receive messages sent by each product indicia reading cash register to the associated central transaction processing computer and to send messages to the associated central transaction processing computer;
providing a communicating data link between the list insertion hub, product reading indicia reading cash registers and associated central transaction processing computer;
producing a coupon shopping list request by manually selecting at least one coupon using the coupon entry apparatus;
manually signaling the request is complete;
automatically assigning a unique identification code to the coupon shopping list being produced in the coupon processing station;
automatically printing the requested coupon shopping list in man-readable format and the unique identification code in cash-register-readable format for use as a shopping aid;
sending a copy of the coupon shopping list, including the unique identification code, to said list insertion hub for storage therein;
using the shopping list, manually selecting for purchase products for which items referenced on the coupon shopping list have redeemable coupons;
taking selected products to a product indicia reading cash register for check-out;
scanning product identification indicia of the selected products for transmission to the associated central transaction processing computer;
recording in the list insertion hub the product identification indicia transmitted from the product indicia reading cash register to the central transaction processing computer;
scanning the unique identification code for transmission to the associated central transaction processing computer;
at the list insertion hub, filtering data transmitted from the product indicia reading cash register to the central transaction processing computer to detect transmission of the unique identification code;
comparing items selected for purchase which have been processed at the cash register to items identified in the coupon shopping list and sending from the list insertion hub to the central transaction processing computer a coupon identification code for which a proper purchase is validated.

14. A method for processing redeemable coupons at a retail establishment according to claim 13 wherein the in-establishment providing step comprises providing a single unit which performs the functions of both the coupon processing station and list insertion hub.

15. A method for processing redeemable coupons at a retail establishment according to claim 13 wherein the controller providing step comprises installing a cell phone data link.

16. A method for processing redeemable coupons at a retail establishment according to claim 13 wherein the establishing step comprises interconnecting the list insertion hub to the product indicia reading cash registers and associated central transaction processing computer via an Ethernet link.

17. A method for processing redeemable coupons at a retail establishment according to claim 13 wherein unique identification code scanning step is performed prior to any product identification indicia scanning step.

18. A method for processing redeemable coupons at a retail establishment according to claim 13 comprising an additional step of transmitting a summary of validated by purchase of product from said list insertion hub to the controller.

19. A method for processing redeemable coupons at a retail establishment according to claim 18 comprising an additional step of electronically billing appropriate originators of coupons in the name of the retail establishment.

20. A method according to claim 13 comprising a further step of generating a coupon shopping list via the Internet.

21. A method according to claim 20 comprising a further step of communicating validated coupon codes to the retail establishment via the Internet.

22. A method for installing a coupon processing subsystem in a retail establishment having product indicia reading cash registers and an associated central transaction processing computer, said method comprising the steps of:
providing the in-establishment coupon processing subsystem comprising:
a coupon processing station comprising a digital processor, coupon entry apparatus and a printer;
a list insertion hub which comprises a communicating data link to the coupon processing station;
disposing the coupon processing station in an area of the retail establishment which is accessible to consumers;
providing electrical power thereto;
electrically affixing the list insertion hub to a common communication link between the product indicia reading cash registers and the associated central transaction processing computer such that data transmitted from the cash registers to the associated processing computer is filtered by the list insertion hub;
establishing a wireless communication link between the coupon processing station and the list insertion hub.

23. A method according to claim 20 wherein the establishing step comprises interconnecting via an Ethernet link.
